(19) United States
(12) Patent Application Publication
(10) Pub. No.: US 2016/0071097 A1
(43) Pub. Date: Mar. 10, 2016

(54) PAYMENT SYSTEM THAT REDUCES OR ELIMINATES THE NEED TO EXCHANGE PERSONAL INFORMATION

(71) Applicant: Silouet, Inc., Cambridge, MA (US)

(72) Inventor: Thomas J. Lazay, Cambridge, MA (US)

(73) Assignee: Silouet, Inc., Cambridge, MA (US)

(21) Appl. No.: 14/478,696

(22) Filed: Sep. 5, 2014

(51) Int. Cl. G06Q 20/38

(52) U.S. Cl. CPC G06Q 20/382

(57) ABSTRACT

A payment system that securely identifies transactions using a transaction identifier that may be set by the parties to the transaction, such that the parties may interact regarding the transaction with one another and with the payment system using that identifier rather than personal identification information. In embodiments, funds may be transferred between individuals that are anonymous to one another, or transferred with limited exchange of personal identification information. When a first individual (the “payer”) seeks to pay a second individual, the first may obtain from the second (the “payee”) an identifier for the transaction. The payer may register the transaction with the payment system, including by providing this transaction identifier. The second individual may subsequently “claim” the transaction by providing that transaction identifier to the system and thereby demonstrating that he/she is the payee of the transaction, after which the system may transfer funds to the second individual.

### BACKGROUND

Payment transactions may exchange funds between two or more people for goods, services, charity, or other reasons. For example, a first person may provide a good or service to a second and receive money from the second person in exchange.

Such a transaction may be carried out using cash, so that one person may provide the cash to the other to carry out the payment transaction.

Alternatively, one or more computerized systems may be used to transfer funds between registered users of the systems so as to carry out a payment transaction between the two users. To initiate a transfer of funds in some such payment systems, a first registered user may (via a user interface) provide to the payment system information identifying another individual to whom to send funds or from whom to request funds. The information identifying the other individual may be a legal name of the person, mailing address, phone number, an email address, or other personal identification information. In response, the system searches its records based on the personal identification information to determine whether the individual identified by that personal identification information is already registered with the system. If so, once the other individual is identified by the payment system, the payment system exchanges funds between the two users. If the individual is not already registered with the system, then the system will communicate with the individual using the personal identification information. The system may, for example, send an email to the individual requesting that the individual register with the system and complete the transaction.

### SUMMARY

In one embodiment, there is provided a method for operating a payment system that processes transactions for one more payments between at least one payers and payees. The payment system comprises at least one data storing information regarding at least one pending transaction. The at least one data store stores, for each pending transaction of the at least one pending transaction, a payment amount, identifying information for a payer, and a transaction identifier. The method comprises operating at least one processor to determine whether a potential transaction identifier input by a user matches a transaction identifier for one of the at least one pending transaction stored in at least one data store and, in response to determining that the potential transaction identifier matches the transaction identifier for a matched pending transaction, determine a privacy setting for the matched pending transaction, and output for display to the user information about the matched pending transaction. The information regarding the matched pending transaction includes an amount of identifying information for the payer of the matched pending transaction based on the privacy setting determined for the matched pending transaction.

In another embodiment, there is provided at least one computer-readable storage medium having encoded thereon executable instructions that, when executed by at least one processor, cause the at least one processor to carry out a method for operating a payment system that processes transactions for one more payments between at least one payers and payees. The payment system comprises at least one data storing information regarding at least one pending transaction. The at least one data store stores, for each pending transaction of the at least one pending transaction, a payment amount, identifying information for a payer, and a transaction identifier. The method comprises operating at least one processor to determine whether a potential transaction identifier input by a user matches a transaction identifier for one of the at least one pending transaction stored in at least one data store and, in response to determining that the potential transaction identifier matches the transaction identifier for a matched pending transaction, determine a privacy setting for the matched pending transaction, and output for display to the user information about the matched pending transaction. The information regarding the matched pending transaction includes an amount of identifying information for the payer of the matched pending transaction based on the privacy setting determined for the matched pending transaction.

In a further embodiment, there is provided an apparatus comprising at least one processor and at least one computer-readable storage medium having encoded thereon executable instructions that, when executed by the at least one processor, cause the at least one processor to carry out a method for operating a payment system that processes transactions for one more payments between at least one payers and payees. The payment system comprises at least one data storing information regarding at least one pending transaction. The at least one data store stores, for each pending transaction of the at least one pending transaction, a payment amount, identifying information for a payer, and a transaction identifier. The method comprises operating at least one processor to determine whether a potential transaction identifier input by a user matches a transaction identifier for one of the at least one pending transaction stored in at least one data store and, in response to determining that the potential transaction identifier matches the transaction identifier for a matched pending transaction, determine a privacy setting for the matched pending transaction, and output for display to the user information about the matched pending transaction. The information regarding the matched pending transaction includes an amount of identifying information for the payer of the matched pending transaction based on the privacy setting determined for the matched pending transaction.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of an environment in which some embodiments may operate;

FIG. 2 is a flowchart of a process that may be implemented in some embodiments for receiving information regarding a payment transaction to initiate that transaction with a payment system;

FIG. 3 is a flowchart of a process that may be implemented in some embodiments for receiving information regarding a payment transaction as part of a non-initiating party claiming that transaction;

FIG. 4 is a flowchart of a process that may be implemented in some embodiments for collecting, from a user at a client device, information regarding a payment transaction to be initiated with a payment system;

FIG. 5 is a flowchart of a process that may be implemented in some embodiments for presenting to a user a list of nearby other users of a payment system with which payment transactions may be initiated;

FIG. 6 is a flowchart of a process that may be implemented in some embodiments for determining, during a registration process for a user, whether that user is a payee of any pending transactions;

FIG. 7 is a flowchart of a process that may be implemented in some embodiments for receiving, from an unregistered user of a payment system, information regarding a payment transaction to be initiated;

FIG. 8 is a flowchart of a process that may be implemented in some embodiments for setting a privacy of a payment transaction;

FIG. 9 is a flowchart of a process that may be implemented in some embodiments for automatically setting a privacy for a payment transaction based on information regarding prior transactions;

FIG. 10 is a flowchart of a process that may be implemented in some embodiments for selecting a confirmation message to be displayed when a user has initiated a payment transaction;

FIG. 11 is a flowchart of a process that may be implemented in some embodiments for configuring a confirmation message for use in confirming initiation of a payment transaction; and

FIG. 12 is a block diagram of a computing device with which some embodiments may operate.

### DETAILED DESCRIPTION

The inventor has recognized and appreciated the value of computerized payment systems, including convenience of performing payment transactions electronically. It may be difficult or inconvenient for some people to use cash (e.g., if the payer is out of cash at the time or the payee cannot make change), credit/debit cards (which require specialized card-reading hardware), or other forms of payment in some circumstances. As such, payment system may make transacting business easier than alternative forms of payment.

The inventor has recognized and appreciated, however, that existing payment systems have drawbacks. Existing payment systems often require that the parties to a payment transaction be identified to one another. For example, the system may require that a payer input the name, phone number, or e-mail address of a payee, which requires that the payer know this information in advance or that the payee disclose this information to the payer. These payment systems therefore do not enable transactions to be carried out when the parties to the transaction are, and wish to remain, anonymous to one another, or when one or both parties would prefer not to exchange information by which they could be easily identified, located, or contacted by the other party following the transaction. The inventor has recognized that there may be many situations in which protecting personal identification information, or reducing possibility of being located or contacted by a lay person following the transaction, may be valuable or important to parties to a transaction, and therefore many situations in which conventional payment systems will not be used. For example, if a restaurant patron wished to tip a waitress by directly paying her through a payment system, the patron would need to ask the waitress for her phone number or e-mail address. The waitress may not feel safe disclosing such information, as the waitress may not want the patron to be able to easily contact her following their transaction. As a result, the patron cannot use the payment system to tip the waitress. Anonymity may be similarly important to one or more parties to a transaction in various other tipping situations, when making charitable donations in which a payer does not want his/her identity known, or in various other circumstances.

The inventor has therefore recognized and appreciated the desirability of an electronic payment system that permits parties to a payment transaction to protect their personal identification information and, in some scenarios, remain anonymous to one another. The inventor has developed specific techniques to both enable such anonymity, safeguard transactions against fraud in such a payment system, and increase reliability to ensure that payments are delivered to correct payees despite the limited exchange of personal identification information.

In some embodiments described herein, a payment system is provided that securely identifies transactions using a transaction identifier that may be set by the parties to the transaction, such that the parties may interact regarding the transaction with one another and with the payment system using that identifier rather than personal identification information. As a result, funds may be transferred with limited exchange of personal identification information between the parties, or transferred between individuals that are anonymous to one another. For example, when a first individual (the “payer” below) seeks to pay a second individual, the first may obtain from the second (the “payee” below) an identifier for the transaction. The payer may then register the transaction with the payment system, including by providing this transaction identifier to the payment system. In some such embodiments, at the time the payer submits the payment transaction to the payment system, the payer does not have personal identification information for the payee, such as contact information or other information that a lay person could use to locate the payer following the transaction. The payer may, in some cases, be unaware of the identity of the payee. The payment system is therefore not informed of the identity of the payee at the time the payer submits the payment transaction to the payment system, and the transaction is held as pending until the transaction is claimed by the payee. Using techniques described herein, the system may later determine the identity of the payee. For example, the second individual may subsequently “claim” the transaction by providing that transaction identifier to the system, thereby demonstrating that he/she is the payee of the transaction, after which the system may transfer funds to the second individual.

Through the use of such a transaction identifier, the parties may exchange only limited information with one another (or even remain anonymous to one another, in some cases) while still allowing the two parties to exchange funds. Additionally, the payment system is able to securely identify an identity of the payee of a transaction without the payer providing the information or even being aware of the identity. By using a transaction identifier that is selected by one or both parties and is a secret to the parties, the transaction identifier can be used to securely identify the parties when they are interacting with the system regarding the transaction. When the payee claims the transaction by providing the transaction identifier, the transaction identifier is used by the payment system to identify the payee of the transaction. The transaction identifier is thus used by the payment system to determine how or where to route funds pursuant to the transaction. In addition, because a payer can initiate a payment transaction without identifying the payee, the payer may easily initiate a payment transaction with a payee who is not yet a registered user of the payment system. As discussed in more detail below, examples of information that may be used as transaction identifiers include alphanumeric identifiers, unique symbols, biometrics identifiers for one of the parties to a transaction (e.g., for the payee), or any other suitable information. It should be appreciated that embodiments are not limited to using any particular type of information as a transaction identifier.

In some embodiments, it may be desirable to use additional information to more securely identify the parties to the transaction when they are interacting with the payment system regarding the transaction. In such a case, any of various types of additional information regarding the payment transaction may be collected by the payment system at a time that the payment transaction is submitted. For example, information on a setting (e.g., time and/or place) of the transaction, information on parties to the transaction (e.g., an appearance of one of the parties or the initials of the name of one of the parties), or information on a basis for the transaction (e.g., a description of a purpose or cause of a transaction, such as of goods or services exchanged as part of the transaction) may be used as the additional information. In some cases, multiple pieces of additional information may be collected and the payment system may use one, some, or all pieces of the additional information to securely identify a party to the payment transaction.

Using additional information to confirm the identity of the parties to the transaction may be advantageous in some embodiments as it may enable the use of transaction identifiers that are more easily remembered by the parties to the transaction, or that may be set or remembered without the payee needing to have or use an electronic device. For example, the transaction identifier may be associated with a payee (e.g., a fingerprint of the payee) or may be selected by the payee (e.g., an alphanumeric code selected by the payee that is short enough to be remembered by an average human, such as one that is between 1 and 8 characters long). In such cases, the payee may find it relatively easy to use or remember the transaction identifier, as opposed to other identifiers that may need to be electronically-captured such as a bar code or a lengthy number that was randomly selected by a computer program. In addition, a payer may initiate a payment transaction with a payee without the payee needing to use, or even possessing, a computing device, reducing a burden on the payee.

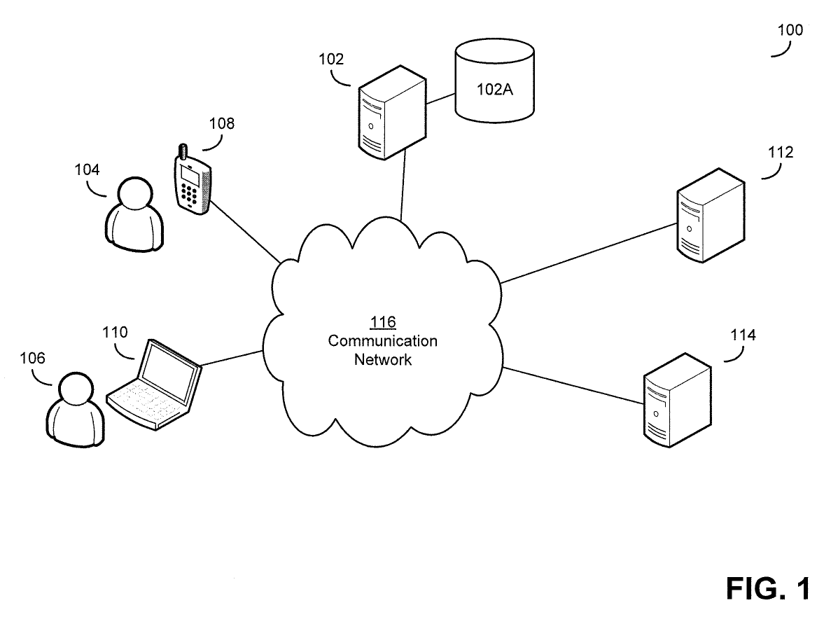

Various embodiments of a payment system that incorporates the above-described techniques and/or other techniques are described below. To provide context for the discussion of these embodiments, FIG. 1 illustrates an example of an environment in which some embodiments may operate. It should be appreciated, however, that embodiments are not limited to operating in the environment illustrated in FIG. 1 or to the specific embodiments described below, as other embodiments are possible.

For ease of description, the example of FIG. 1 and various examples below are described in connection with a payer initiating a payment transaction to pay a payee using a payment system, after which the payee identifies himself or herself to the payment system to claim the transaction and receive the funds from the payer. It should be appreciated, however, that embodiments may additionally or alternatively permit a payee to initiate a payment transaction to request funds from a payer, after which the payer identifies himself or herself to the payment system to authorize the transaction and send the funds to the payee. In such a case, the payee may provide to the payment system the information that is described below as being provided by the payer, and the payer may provide to the payment system the information described below as being provided by the payee. Further, for ease of description the parties may be described as human individuals, but it should be appreciated that one or more parties to a transaction may be a business or other organization. In circumstances in which a party is a business/organization, information on one or more agents of the business/organization may be received and stored by a payment system and used to process transactions. For example, a facial image of an employee of a business may be registered with the payment system and may also be received as a transaction identifier when a payment transaction is initiated. As another example, information collected from a device of an employee of a business/organization, such as a history of locations, may be received and stored by the payment system.

The environment 100 of FIG. 1 includes payment system 102 (including one or more servers executing a server payment facility), a payer 104, a payee 106, and computing devices 108, 110 that execute client payment facilities and are respectively operated by the payer 104 and payee 106 (who may be human individuals) to interact with the payment system 102 and carry out payment transactions. As part of processing payment transactions, the payment system 102 may additionally interact with computing devices 112, 114 that may be associated with financial institutions that manage financial accounts (e.g., checking accounts, credit accounts, etc.) for the payer 104 and payee 106, and/or may be associated with one or more payment processing networks. The computing devices may be interconnected by one or more computer communication networks, which may be any suitable wired and/or wireless networks including local area networks, wide area networks, and/or the Internet.

The payment system 102 may be implemented as a computing device or set of computing devices (e.g., one or more servers) executing instructions for a server payment facility that implements some of the techniques described herein. For example, the payment system 102 may receive from parties to a payment transaction information regarding a transaction and transfer funds in accordance with the transactions. The payment system 102 may include one or more data stores 102A that store information about payment transactions and registered users of the payment system.

The information stored by the data store 102A on the payment transactions may include any suitable information about a transaction. For example, for each transaction the data store 102A may store a transaction identifier submitted by one or more of the parties to a transaction, an amount of funds to be exchanged in the transaction, information on a party initiating the transaction (e.g., an identity of a payee), and additional information regarding the transaction. Various types of additional information are discussed below, including information on a setting of the transaction, information on the parties to the transaction, or information on a basis of the transaction. The information on the payment transactions may include information on pending transactions, for which the payment system 102 only stores information on the identity of one party to the transaction, as another party to the transaction has not yet identified himself or herself to claim or authorize the transaction. For ease of description, information on such a transaction for which the system 102 stores information on only one party (e.g., the initiating party) may be referred to below as information on a “pending” transaction. The information on payment transactions may also, however, include information on transactions for which the payment system 102 stores information on two or more parties to a transaction, including transactions that have already been claimed by a payee and for which the funds have already been transferred. Such transactions may be referred to below as “completed” transactions, for ease of description.

The information stored by the data store 102A on the registered users of the payment system may also include any suitable information on the users, including personal identification information. For example, the data store 102A may store legal names of the users, contact information for the users (e.g., mailing addresses, e-mail addresses, phone numbers, or any other suitable contact information), or financial account information. The financial account information may include any suitable information to carry out a credit or debit transaction for a financial account. The payment system 102 may be configurable to carry out credit or debit transactions in any suitable manner, as embodiments are not limited in this respect, and embodiments are therefore not limited to operating with any particular type of financial account information. For example, the payment system 102 may be configurable to carry out one or more of electronic funds transfers (EFTs) such as automated clearinghouse (ACH) or wire transactions, credit or debit card transactions, transfers of digital currency (e.g., a cryptocurrency such as bitcoins), or other credit or debit transactions. In some cases, the information on a registered user may include information on a type of transaction that the user has configured the payment system 102 to perform for that user, which may be based on the type of financial account information provided by that user to the payment system 102 or based on an explicit selection by the user of a type of transaction. For example, the financial account information for one user may include information that may be used to wire funds to or from a checking account, while the financial account information for another user may include information that may be used to credit or debit a revolving credit account (e.g., a credit card account) for that other user.

Accordingly, the financial account information that is stored by the payment system 102 for a user may include any suitable information and may correspond to the type of transactions that the payment system 102 is configured to perform in general or for that specific user. The financial account information may include one or more financial account numbers (e.g., account numbers or routing numbers), expiration dates, security codes, or any other suitable information, as embodiments are not limited in this respect. When a digital currency such as bitcoins is to be used, the financial account information may be based on the manner in which the digital currency is exchanged. For example, in the case of a bitcoin where the currency is linked to a particular piece of transferable computer data (e.g., a computer file), the financial account information may include information on a computing device or storage device on which the computer data is stored and on how to transfer that computer data from that computing/storage device.

In the example transaction of FIG. 1, the payer 104 may wish to transfer funds to the payee 106 using the payment system 102. The payer 104 may wish to pay the payee 106 for any reason—such as purchasing goods or services, tipping for goods or services, or making a charitable donation—as embodiments are not limited to payment transactions having any particular purpose or cause. Prior to the payment transaction, one or both of the payer 104 and payee 106 may be registered users of the payment system 102. Accordingly, the payment system 102 may store in the data store 102A personal identification information for the payer 104 and/or payee 106 before the start of the transaction. As part of the transaction, as discussed below, the payer 104 (or, in other cases, the payee 106) may provide information about the payment transaction to the payment system 102 for storage in the data store 102A.

To initiate the payment transaction, the payer 104 may operate the computing device 108. The device 108 is illustrated in FIG. 1 as a smart phone, but it should be appreciated that embodiments are not limited to operating with any particular type of mobile device. The device 108 may include, as part of a client payment facility executing on the device 108, a user interface for the payment system 102. The client payment facility may be implemented in any suitable manner, as embodiments are not limited in this respect. In some embodiments, the client payment facility may be implemented as part of a web page downloaded by the device 108, while in other embodiments the client payment facility may be an application that is specific to the payment system 102 and that executes on the device 108. In still other embodiments, multiple types of client payment facilities for the payment system 102 may available.

As discussed in more detail below, in accordance with techniques described herein the payer 104 may input to the user interface of the client payment facility various information regarding the payment transaction to be performed by the payment system 102. The information may include a payment amount, a transaction identifier, and any suitable additional information. In some embodiments, the payer 104 may obtain some information from the payee 106, including the transaction identifier. For example, in some embodiments the transaction identifier may be an alphanumeric code and the payee 106 may input the code to the device 108 or provide it to the payer 104 for input. As another example, in some embodiments the transaction identifier may be biometric information for the payee 106, such as a facial image, voice print, or fingerprint, and the payer 104 may obtain the biometric information from the payee 106, such as by taking a picture of the face of the payee 106. However, in other cases the payer 104 may set the transaction identifier. In such a case, the payer 104 should inform the payee 106 of the transaction identifier so that the payee 106 can interact with the payment system 102 to claim the transaction, as will be appreciated from the discussion below. In some embodiments, after the payment transaction has been initiated, a user interface on the device 108 may display a confirmation message that may include the transaction identifier, and the payer 104 may show the display to the payee 106 to remind or inform the payee 106 of the transaction identifier. As an alternative, the payer 104 may verbally convey a transaction identifier to the payee 106.

In accordance with techniques described herein, in some embodiments the information that the payer 104 inputs to the device 108, and the information obtained by the payer 104 from the payee 106, does not include any personal identification information about the payee 106. In many scenarios, parties to a transaction that is carried out using a payment system 102 may be lay persons, and may in some cases additionally be persons having limited prior contact with one another and may have limited future contact. In such cases, a degree of desired anonymity may extend to exchange of information that itself indicates a name or contact information for the parties. Thus, in embodiments, information obtained by the payer 104 from the payee 106 may not be personal identification information because it may not be information that could be used by a lay person to directly identify or contact the payee 106. Such information may not be information that directly informs the payer 104 of the name of the payee 106, or may not be information that directly enables the payer 104 to contact the payee 106, in cases in which the payer 104 is a lay person. In embodiments, exchanged information may not include a name of a person or information that directly enables a lay person to contact that person (e.g., a phone number or e-mail address).

As discussed below, in some embodiments biometric information is exchanged and may be used as a transaction identifier. For example, a fingerprint or facial image may be used as a transaction identifier. Of course, such biometric information may uniquely identify a person and might be useful by non-lay persons in determining that person's identity. For example, while biometric information like a fingerprint may not itself convey name or contact information on a person, a fingerprint could be used by a skilled person with access to databases of fingerprint information (e.g., a law enforcement officer) to obtain such information. However, parties to a transaction using the payment system may not be concerned about sharing such information as the information cannot be used by lay persons to determine name or contact information. Accordingly, while in some embodiments information that is uniquely or distinctively associated with a party may be shared between parties to a transaction, in such embodiments name or contact information, or other personal identification information, may not be shared. By not exchanging personal identification information, in a case that the payee 106 is anonymous to the payer 104, the payee 106 may remain anonymous to the payer 104 (to a degree desired by the parties) despite receiving a payment from the payer 104.

Once the information regarding the payment transaction is input to the client payment facility of the device 108, the client payment facility uploads that information to the payment system 102. Upon receipt, the payment system 102 stores the information regarding the transaction in the data store 102A. As discussed above, at the time the information about the payment transaction is uploaded by the payer 104, the information may not identify the payee 106. This may be because the anonymity between the parties permitted by the payment system 102 prevents the payer 104 from having any information on an identity of the payee 106 to input for upload. Accordingly, upon receipt of the information regarding the payment transaction, the payment system 102 may not store any information linking the payee 106 to the payment transaction or otherwise identifying the payee 106 of the payment transaction.

Subsequently, the payee 106 may operate another computing device 110 to “claim” the payment transaction by identifying himself or herself to the payment system 102 as the payee of that transaction, after which the system 102 may transfer the funds to the payee 106 (directly or to a financial account of the payee 106). The device 110 is illustrated in FIG. 1 as a laptop personal computer, but it should be appreciated that embodiments are not limited to operating with any particular form of computing device. The payee 106 may use a client payment facility (which may be implemented as one or more web pages, as an application, or in any other manner) of the payment system 102 to claim the transaction. Details of various ways in which the payee 106 may claim a transaction are described in detail below. In brief, the payee 106 may input the transaction identifier and, in some embodiments, additional information regarding the transaction into the client payment facility executing on the device 110. The client payment facility then uploads this information to the payment system 102. Upon receipt of the information, the payment system 102 compares the received information to information on previously-submitted, pending payment transactions to identify whether the received information corresponds to a pending transaction. Specific ways in which the payment system 102 may carry out the comparison are described in detail below. If the payment system 102 determines that the received information corresponds to the transaction that was submitted by the payer 104 via the device 108, then the payment system 102 may determine that the payee 106 is the payee for that transaction. In response to the determination, the payment system 102 may update the data store 102A to identify the payee 106 as the payee of the transaction, may update the data store 102A to change a status of that transaction from “pending” to another state (e.g., “completed”), and may initiate a transfer of funds to the payee 106 in accordance with the payment transaction.

As discussed above, the payment system 102 is not limited to transferring funds in any particular manner ACH transactions, wire transfers, credit or debit card transactions, transfers of digital currencies, or other ways of transferring funds may be used. In some embodiments, the payment system 102 may issue instructions to one or both of a financial institution that manages a financial account associated with the payer 104 and a financial institution that manages a financial account associated with the payee 106. For example, the payment system 102 may issue funds transfer instructions to one or both of a server 112 associated with a financial institution of the payer 104 and server 114 associated with another financial institution of the payee 106. (Of course, it should be appreciated that in some cases the payer 104 and payee 106 may have a same financial institution.) In such embodiments, as a result of these instructions, a debit may be made from an account of the payer 104 and a credit may be made to an account of the payee 106. As another example, the servers 112, 114 may each be associated with a payment processing network for one or more financial institutions, such as payment processing networks that are associated with credit and/or debit card transactions. Such payment processing networks, and techniques for interacting with them to complete transactions, are known and need not be described in detail herein. In brief, the payment system 102 may issue an instruction to a payment processing network associated with the payer 104 and/or the payee 106 to carry out a payment in connection with a transaction. As another example, one or both of the servers 112, 114 may be associated with organizations that may provide incentives, such as bonuses or services, to a user of the payment system if the user transfers funds from the payment system to the organization. For example, a company may be willing to provide a bonus to a user if the user transfers funds received via the payment system as part of a transaction to the company, such as to purchase goods, services, or a gift card from the company. As a specific example, a retailer may provide a bonus of 10% to a gift card if a user transfers funds from the payment system to a gift card redeemable with the retailer. Thus, if the user receives $100 as part of a payment transaction conducted via the payment system and then uses those funds to purchase a gift card with the retailer, the retailer may issue a gift card to the user that is worth $110. It should be appreciated, however, that embodiments are not limited to operating with gift cards. Embodiments may operate with any other suitable incentive program that provides a user a surplus value when users use funds received via payment transactions to purchase goods and/or services from organizations.

As discussed above, the payment system 102 is not limited to performing the funds transfer associated with a payment transaction in any particular manner. In some embodiments, in addition to or as an alternative to operating directly with financial institutions for payers/payees, the payment system 102 may maintain for registered users financial accounts that are specific to the payment system 102 and maintained internal to the system 102 (including by a bank associated with the payment system 102). In such an embodiment, users may be able to credit funds to the internal payment system account from outside financial accounts, and may be able to debit funds from the payment system account to transfer to outside financial accounts or to other users of the payment system via payment transactions. In embodiments that include such internal accounts, the payment system 102 may directly transfer funds between internal accounts for the payer 104 and the payee 106, if both users have such accounts with the payment system 102. Some such accounts may be funded using digital currencies in some embodiments, in which case a transfer (between parties to a transaction) of computer data corresponding to digital currencies may occur within the payment system 102.

The payment facility executed by the payment system 102 and the client payment facilities executing by the devices 108, 110 may be implemented in any suitable manner, as embodiments are not limited in this respect. Described below are examples of various processes that may be implemented by the payment facility or client payment facilities in some embodiments. It should be appreciated, however, that embodiments are not limited to operating in accordance with these examples.

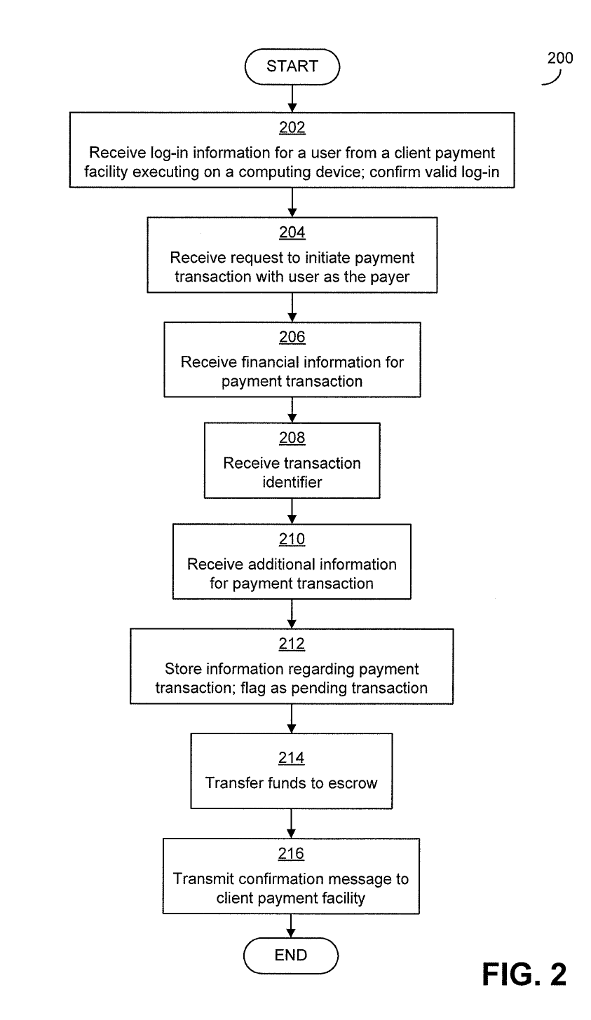

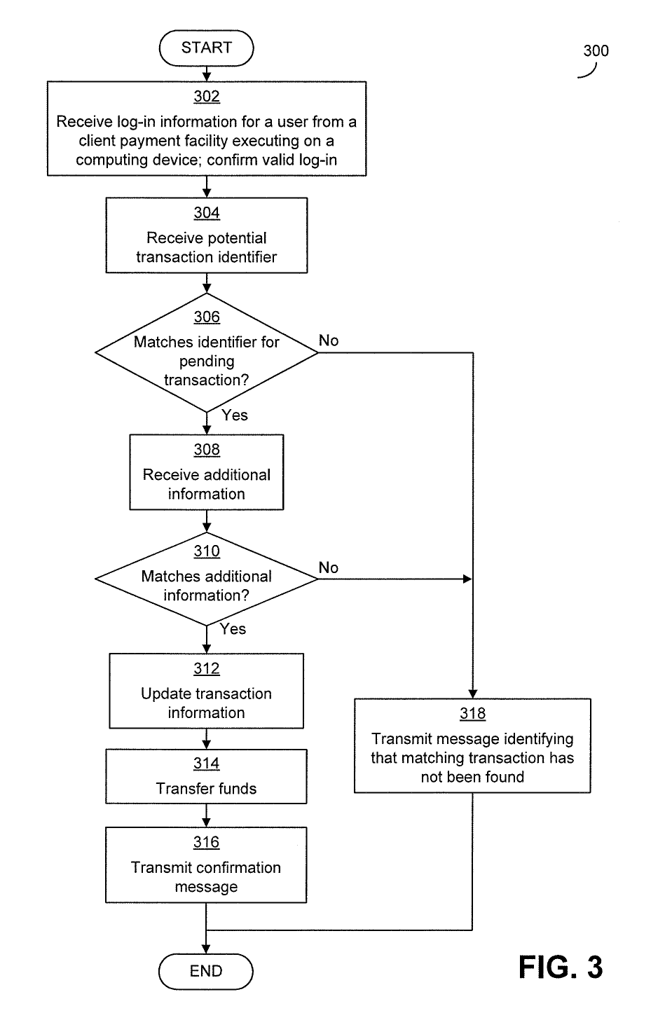

FIGS. 2-3 illustrate examples of processes by which a server payment facility (which may be executed by one or more computing devices of a payment system) may interact with parties to a payment transaction to carry out that transaction. Specifically, FIG. 2 illustrates a process by which a server payment facility may receive information (transmitted by a client payment facility executing on a computing device) from one party to a payment transaction informing the payment system of the payment transaction that is to be performed and FIG. 3 illustrates a process by which the server payment facility may receive information (transmitted by another client payment facility executing on another computing device) identifying the other party to that payment transaction and complete the transaction. As mentioned above, for ease of description, in these examples the payer will be described as the party that first informs the payment system of the transaction (as in FIG. 2) and thereby initiates the transaction, after which the system may identify another party as the payee of the transaction when that party claims the transaction (as in FIG. 3), but embodiments are not so limited.

Prior to the start of the process 200 of FIG. 2, a user who is to be the payer in a transaction may have registered with the payment system. As part of registration, the user may have provided personal identification information about the user to the payment system, such as a legal name and contact information. The user may additionally have provided biometric information, such as a facial image, voice print, fingerprint, or other information. As part of registration, the user may additionally have provided information on one or more financial accounts. In embodiments in which the payment system maintains internal financial accounts, the user may have also transferred funds from an outside source (e.g., a financial institution) to the internal financial account. The personal identification information and financial account information for the user may have been received in any suitable manner, as embodiments are not limited in this respect. In some embodiments, the information may have been transmitted to the payment system by a client payment facility (executing on a computing device) having a user interface into which the information was input.

The process 200 begins in block 202, in which the server payment facility receives information identifying that the user is requesting access to a user's account with the payment system (i.e., “logging in”). The information may be any suitable information, as embodiments are not limited in this respect. For example, the information may be a user name, password, a device identifier for a device operated by the user, or other suitable information that may securely identify the user and prevent others from misusing the user's account, such as to send fraudulent payments. Following receipt of the log-in information and confirmation by the server payment facility that the log-in information is valid, the payment system may be ready to accept payment transaction information from that user.

Accordingly, starting in block 204, the server payment facility may receive from a client payment facility a notification that the user would like to initiate a payment transaction. The information received in block 204 may identify that the user is to act as the payer in the transaction. In block 206, the server payment facility receives financial information for the payment transaction. The financial information may include at least a payment amount identifying the amount of funds to be exchanged in the transaction. The information may additionally identify a source of funds to be used in the transaction, such as by identifying a financial account of the user from which the funds are to be transferred.

In block 208, the server payment facility receives a transaction identifier for the payment transaction. As should be appreciated from the foregoing, embodiments are not limited to using any specific type of information as a transaction identifier. In some embodiments, the transaction identifier may be a string of characters, such as a combination of letters, numbers, and/or punctuation characters of any suitable length. In some cases in which the transaction identifier is a string of characters, the string may be a word or phrase in a human language, such as an English word or phrase. In the case that the transaction identifier is a string of characters, the string may be received in any suitable manner. For example, the string itself may be communicated to the server payment facility from a client payment facility. As another example, audio corresponding to the string of characters (e.g., audio corresponding to a word or number) may be transmitted by the client payment facility to an automatic speech recognizer, which may be integrated with or separate from the server payment facility. After automatic speech recognition techniques are used to generate a string of characters, the string of characters may be received by the server payment facility.

In other embodiments, the transaction identifier may be a symbol. Such a symbol may be an image, such as a photograph, a computer-generated image (e.g., a bar code or Quick Response (QR) code), a drawing, or other image. The symbol may be one that was input by one of the parties to a client payment facility and which the payment system did not previously store, or may be a symbol selected by one of the parties to the transaction from a set of symbols with which the payment system was preconfigured. In a case that such a preconfigured symbol is used as the transaction identifier, receiving the transaction identifier in block 208 may include receiving an identifier for the selected symbol, rather than receiving the symbol itself. In other cases, however, receiving the transaction identifier in block 208 may include receiving image data for a symbol.

In still other embodiments, audio data may be used as the transaction identifier. For example, a sequence of tones or a clip from a song may be used as the audio data. The audio data may be audio that was input by one of the parties to a client payment facility and which the payment system did not previously store, or may be audio data selected by one of the parties to the transaction from a set of audio data with which the payment system was preconfigured. In a case that such preconfigured audio data is used as the transaction identifier, receiving the transaction identifier in block 208 may include receiving an identifier for the selected audio data, rather than receiving the audio data itself. In other cases, however, receiving the transaction identifier in block 208 may include receiving audio data.

As discussed in further detail below, in some embodiments (including some embodiments in which a string of characters, a symbol, or audio data is used as the transaction identifier), the server payment facility or client payment facility may select the transaction identifier on behalf of the parties to the transaction. In a case that the server payment facility selects the transaction identifier, after receiving the notification in block 204, the server payment facility may generate the transaction identifier and send it to the client payment facility. In such a case, when the transaction identifier is received in block 208 this may act as confirmation from the parties to the transaction that the generated transaction identifier is to be used in the transaction, as in some embodiments the client and server payment facilities may enable the parties to reject a generated transaction identifier and request another, such as in a case that the parties believe the generated transaction identifier would be too difficult to remember. In other embodiments, the client payment facility may generate the transaction identifier and, upon approval by the parties, transmit it to the server payment facility. In still other embodiments, the parties may input the transaction identifier to the client payment facility, or select the transaction identifier from a set of preconfigured identifiers displayed in a user interface of the client payment facility, after which the client payment facility transmits the identifier to the server payment facility.

Biometric information for one of the parties may also, in some embodiments, be used as the transaction identifier. The biometric information that is used may be biometric information from the party that does not initiate the transaction, which in the case of FIG. 2 is the payee as the payer is initiating the transaction. Biometric information for the non-initiating party may be used because that party can subsequently obtain and submit his/her own biometric information when the party later claims or authorizes the transaction. (As mentioned above, for ease of description, in this example the non-initiating party is the payee.)

Any suitable biometric information may be received in block 208 in those embodiments that use biometric information as a transaction identifier. For example, in block 208 the server payment facility may receive a facial image of the payee. The facial image may have been one captured by the payer using the client payment facility and a camera, which may be a camera integrated into the device executing the client payment facility (e.g., a camera of a smart phone). In some embodiments in which a facial image is used as the transaction identifier and is captured using the client payment facility, the client payment facility may digitally watermark the facial image to identify the facial image as one that was captured with the facility, as part of mitigating fraud. Accordingly, the facial image that is received in block 208 (in embodiments that use facial images) may include a digital watermark. In such cases, before the facial image is stored, the facility may check the watermark of the facial image for authenticity and may transmit an error message rejecting the image if the watermark cannot be authenticated. Any suitable watermarking technique may be used, as the techniques described herein are not limited to using any particular watermarking technique.

As another example of biometric information, a fingerprint of the payee may be collected and used. The fingerprint may be collected in any suitable manner, including by using a camera of a device executing the client payment facility, a fingerprint reader, or other ways. In embodiments that use fingerprints to identify a transaction, the server payment facility may receive the fingerprint in any suitable manner in block 208, depending on the manner in which the fingerprint was collected. For example, the server payment facility may receive a photograph of the fingerprint, may receive a list of fingerprint characteristics such as loops, whorls, and arches and the locations of those characteristics in the fingerprint, or may receive any other suitable information.

A voiceprint of the payee may be used as the biometric information in some embodiments. The voiceprint may be an audio sample of the user's voice or data that characterizes a voice of the payee with features of the payee's voice such as formants of the payee's voice, a pitch range of the payee's voice, a tenor of the payee's voice, or other acoustic information. The voiceprint may be determined in any suitable manner, including by performing voice analysis techniques on audio of the payee speaking to produce information that identifies the payee's voice uniquely or that would distinguish the payee's voice from at least some other voices. In embodiments that use a voiceprint, audio may be transmitted by the client payment facility to a voice analyzer that may be integrated with or separate from the server payment facility. After voice analysis is carried on the audio to produce the voiceprint information, the voiceprint information may be received by the server payment facility.

In some embodiments, information on a computing device operated by a payee, or on a client payment facility executing on such a computing device, may be used as a transaction identifier. For example, in some embodiments a computing device may include a unique or distinctive identifier, such as a device serial number, an identifier for a network interface (e.g., a Medium Access Control (MAC) address), or other identifier. As another example, a client payment facility may include a unique or distinctive identifier, such as an identifier assigned by a server payment facility upon a valid log-in of a user via that client payment facility. In such cases, the device identifier may be transmitted from a payee's device to a payer's device using a networking protocol. For example, a wireless communication protocol such as IEEE 802.11, Bluetooth®, or Near Field Communications (NFC) may be used. Once the device identifier for the payee's device is received by the payer's device, the client payment facility executing on the payer's device may upload the device identifier to a server payment facility as a transaction identifier.

In some embodiments a gesture may be used in some embodiments as a transaction identifier. For example, a device may electronically capture an image (e.g., a sequence of one or more images, or a video) of a payee making a gesture with his/her hands and the image may be processed to produce an electronic representation of the gesture. Image-processing techniques to analyze images of gestures and determine an electronic representation of the gesture are known and thus need not be described in detail herein. In some embodiments, such image-processing techniques may be resource-intensive and may be performed by an image-processing facility that is integrated with or separated from the server payment facility, rather than being performed by a client payment facility or otherwise performed on a user's device. As another example, a user interface for receiving a gesture may be displayed on a touchscreen of the initiating party's device (e.g., the payer's device) and the payee may be prompted to trace a finger or stylus on the touchscreen to input a gesture that is a particular shape. In embodiments that implement such a touchscreen gesture as a transaction identifier, the trace may be any suitable trace, including a trace through a virtual keyboard of numbers and letters or a freeform trace on a user interface without buttons or other graphics, as embodiments are not limited in this respect. A trace may be subsequently processed in any suitable manner to produce information regarding the trace, including using known trace processing techniques, as embodiments are not limited in this respect.

In some embodiments, additional information describing a transaction may be received by the server payment facility in block 210, in addition to the transaction identifier. Any suitable additional information may be received, as embodiments are not limited in this respect. In some embodiments, the additional information may include information on a context of a transaction. The context of a transaction may include information on the circumstances in which the transaction was initiated or that led to the transaction being initiated. Information on a context of the transaction may include information on a setting of a transaction, which may include information on the time or place of the transaction. For example, in some embodiments, a geographic location and/or time of the transaction may be received in block 210. Such geographic location or time may be automatically determined by a client payment facility and transmitted to the server payment facility, such as through use of a GPS receiver integrated with the device on which the client payment facility is executing, or may be input by the payer. As another example of such additional information, information on the parties to the transaction may be received. For example, a description of the appearance of the payer and/or payee at the time the transaction was initiated may be received in block 210. The description may be any suitable description that may be input by one of the parties to the transaction, as embodiments are not limited in this respect. For example, the description may include a description of the clothing, hair color, eye color, skin color, tattoos, piercings, gender, or other distinguishing features of the appearance of either of the parties. Information on one of the parties to a transaction may also include the initials of the name of that party, such as the initials of the first, middle, and/or last name of the payer. As another example, information on a basis of the transaction may be received. The information on the basis of the transaction may include information on a cause of the transaction, or a purpose of the transaction. For example, if the transaction is a charitable donation, this may be indicated by the information on the basis of the transaction. If the transaction is a payment in exchange for damage or an injury, this may be indicated by the information on the basis of the transaction. The information on the basis may include a description of goods or services exchanged in the transaction, in cases in which goods/services are exchanged. Any suitable additional information may be received by the server payment facility, as embodiments are not limited in this respect.

Once the payment amount, transaction identifier, and additional information are received in blocks 206, 208, 210, the server payment facility may store information regarding the payment transaction in a data store in block 212. The information regarding the payment transaction may include each of the pieces of information received, including the identity of the user that is to serve as the payer. In some embodiments, the information regarding the transaction may also include a time that the information was stored by the server payment facility. In some embodiments, a payment transaction may expire after a threshold period of time has passed without the transaction being claimed by a payee. In these embodiments, the server payment facility may use the time that the information was stored to determine whether the threshold time has passed, after which the transaction is canceled. If a transaction is canceled and (as discussed below) funds for the transaction had already been transferred into escrow, the funds may be refunded to the payer's financial account.

As should be appreciated from the foregoing, in some embodiments, when the information on the payment transaction is stored, the information may not identify a payee of the transaction, as the received information may not identify the payee. Accordingly, the information on the payment transaction may identify only one party to the transaction, when there may be two or more parties. The server payment facility may also store (or issue an instruction to another facility to store) information that flags the transaction as a “pending” transaction, which may indicate that the parties to the transaction (e.g., the payee of the transaction) have not yet been fully identified.

The server payment facility may also, in some embodiments, transfer funds from a financial account of the payer into an escrow account, as illustrated in block 214 of FIG. 2. The payment system may do this to ensure that the payer has sufficient funds to cover the amount of the transaction, and to reserve those funds for performing the transaction before the payer carries out other transactions. The transfer of funds may be carried out in any suitable manner, as embodiments are not limited in this respect. For example, the server payment facility may transfer funds from a financial account associated with the payer to a financial account associated with the payment system. The facility may do this by issuing any suitable instruction, including an instruction to a financial institution that manages the financial account of the payer. In some embodiments, rather than transfer funds to escrow, the server payment facility may instead confirm the availability of funds to cover the amount of the payment transaction and may additional marked the funds as reserved in any suitable manner, but may not transfer the funds into escrow.

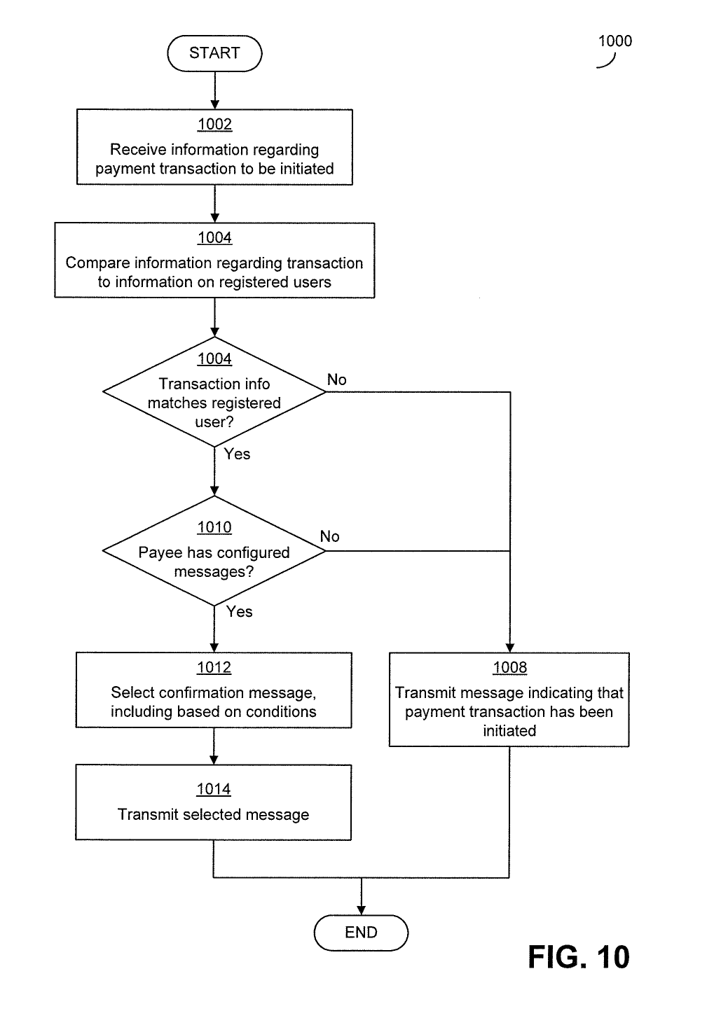

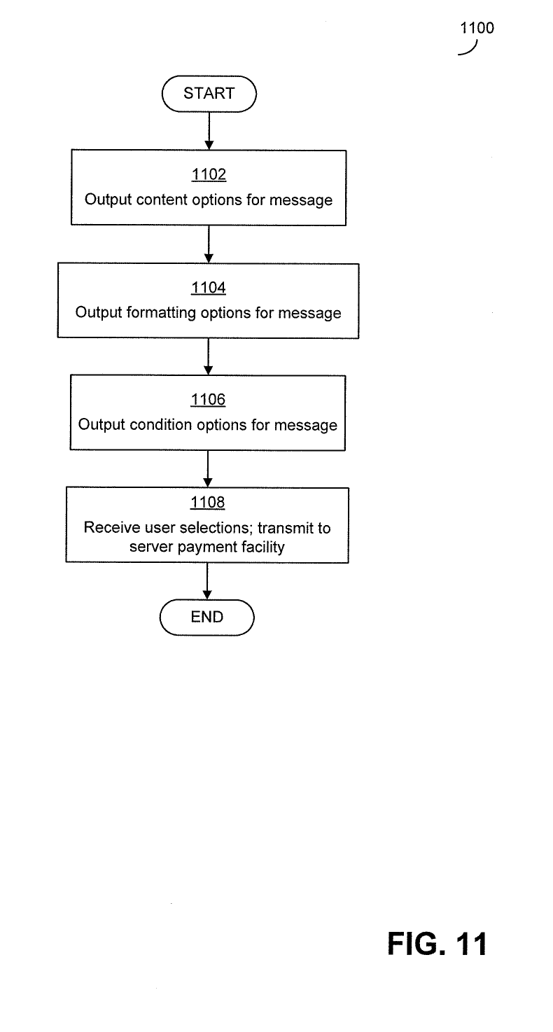

The server payment facility, in block 216, transmits a message to the client payment facility from which the information was received to confirm that the information on the payment transaction was received and (in embodiments that transfer funds to escrow) that the funds have been transferred. The confirmation message may include any suitable information. For example, the confirmation message may include the transaction identifier, information regarding the parties to the transaction such as facial images or partial names, an amount of the transaction, a time of the transaction, and/or a map illustrating a location of the transaction. As discussed below in connection with FIGS. 10-11, in some embodiments a message that is specific to one of the parties to the transaction may be transmitted. Once the confirmation is transmitted in block 216, the process 200 ends.

As a result of the process 200, the payment system stores information on a pending transaction. This transaction can then be “claimed” by a payee of the transaction at any later time, so that the payee can inform the payment system that he/she is the intended recipient of the funds to be transferred in the transaction and to trigger the transfer of funds to a financial account of the payee. Such a claiming process may be carried out in any suitable manner. FIG. 3 illustrates an example of such a process.

The process 300 may be implemented by a server payment facility and may be used to determine whether a user of the payment system is a payee of a transaction and, if so, to transfer funds to that user. Prior to the start of the process 300 of FIG. 3, the payment system may receive and store information on one or more payment transactions. In addition, as discussed above in connection with FIG. 2, the user may register with the payment system and provide information about himself or herself and about a financial account.

The process 300 begins in block 302, in which the server payment facility receives log-in information for the user. The server payment facility may implement this in any suitable manner, including using techniques described in connection with block 202 of FIG. 2.

In block 304, after the payment system has confirmed that the user is validly logged-in to his or her own account, the system may receive from the user a request to claim a transaction. The request may be received from a client payment facility and may include any suitable information, including a potential transaction identifier. This transaction identifier is termed a “potential” transaction identifier here because, at the time it is received by the server payment facility, the facility may not be aware of whether the identifier corresponds to any transaction. Rather, the facility will carry out the process 300 to determine whether the identifier corresponds to a pending transaction and whether the user is the payee of that transaction.

Accordingly, in block 306, the server payment facility determines whether the potential transaction identifier matches a transaction identifier for any of the pending transactions stored in one or more data stores maintained by the facility. The facility may make the determination in any suitable manner, as embodiments are not limited in this respect. For example, the facility may search the data store for a transaction having an identifier matching the received identifier.

As should be appreciated from the foregoing discussion of FIG. 2, it should be appreciated that embodiments are not limited to receiving any specific type of information in block 304 or conducting any particular type of determination using that information in block 306. Any of various types of information, including the examples discussed above in connection with block 208 of FIG. 2, may be used as a transaction identifier in embodiments. Accordingly, receipt of a proposed transaction identifier in block 304 may include receipt of any of the types of information discussed above in connection with block 208, including strings of characters, audio corresponding to such strings of characters, symbols, audio, or biometric information. Depending on the type of information used as the transaction identifier and received in block 304, the determination of block 306 may be made in various ways. For example, if the received potential transaction identifier is a string of characters, the determination of block 306 may include determining whether an identifier for a pending transaction precisely equals that received potential identifier. As another example, if the received potential transaction identifier is a biometric identifier, known techniques for comparing biometric identifiers may be used to determine whether the potential transaction identifier is a match to a biometric identifier for a pending transaction. As another example, if the received potential transaction identifier is a gesture, known techniques for comparing images of gestures or traces on a touchscreen interface may be used to determine whether the potential transaction identifier is a match to the gesture stored for a pending transaction. Using such known techniques, precise equivalency between the biometric identifiers may not be determined, but instead it may be determined whether the biometric identifiers have a likelihood of match above a threshold.

If the server payment facility determines in block 306 that there is a match between the potential transaction identifier received in block 304 and a transaction identifier for a pending transaction, in some embodiments the facility may determine that the user is the payee of that transaction and move on to processing the transaction as in block 312 below. However, in other embodiments, to mitigate fraud, additional information may be used in block 308, 310 to confirm that the user is the payee of the transaction. Additionally, in some cases (such as those that use preconfigured symbols to identify transactions), there may be transactions that use the same identifiers and that are identified in block 306, and additional information may be necessary to identify which transaction the user is claiming.

The additional information that is received in block 308 and used to confirm whether the user is the payee may be any of the various types of additional information described above in connection with block 210, such as information on a context of the transaction, information on the parties to the transaction, and/or information on a basis of the transaction. The server payment facility may, in some cases, prompt the user (such as by sending a message to a client payment facility executing on a device operated by the user) to input additional information of a type (or types) that corresponds to the type(s) of additional information that is stored in the data store for the transaction. For example, if the additional information stored for the payment transaction includes a description of the appearance of the payer, the server payment facility may prompt the user to input a description of the payer. As other examples, the server payment facility may specifically prompt the user to input a location or time, or the initials of the payer. In other embodiments, however, to increase security, the client payment facility may simply include a user interface with options to input each of the available types of additional information for a transaction, and it may be left to the user to input corresponding additional information. This may require that the user recall what type of additional information was provided at the time the transaction was initiated (as in FIG. 2), but may increase the likelihood that, if the additional information matches, the user truly is the payee of the transaction.

Once the additional information is received by the server payment facility in block 308, in block 310 the facility may compare the received additional information to the additional information that was stored for the transaction(s) that have the identifier received in block 304 to determine whether there is a match. The facility may determine whether there is a match in any suitable manner, as embodiments are not limited in this respect. In some embodiments, the facility may determine whether there is a match by determining whether there is a precise equivalence between the additional information stored for a transaction and the additional information received in block 308.

In other embodiments, however, the facility may tolerate some imprecision or discrepancy between the stored additional information and the additional information received in block 308. For example, if the additional information is or includes a time, the facility may determine whether there is a match if a time input in block 308 is within a threshold amount of time of the time stored for the transaction. Accordingly, in some cases if the stored time for a transaction is 1:57 pm and the time received in block 308 is 2 pm, the facility may determine that there is a match. Similarly, in some cases if a stored location for a transaction is a precise latitude, longitude, and altitude for a geographic position, the facility may determine a match to a location received in block 308 if that location is within a threshold distance of that geographic position.

In some embodiments that allow such imprecision and use thresholds to determine whether there is a match, the threshold may be set by the initiating party of the transaction (e.g., a payer) or may be set based on information regarding the transaction. Any suitable information regarding the transaction may be used to set the threshold, as embodiments are not limited in this respect. In some embodiments, information regarding a context of a transaction may be used. For example, with respect to thresholds that relate to location, if the location of the transaction is an area that is densely populated (e.g., midtown Manhattan), a smaller threshold may be used than would be used for an area that is not densely populated (e.g., rural Montana). As a result, a user that is claiming a transaction that took place in midtown Manhattan may have to specify a location within a few hundred feet of the stored location for the transaction, whereas a user that is claiming a transaction that took place in rural Montana may be able to specify a location that is within a mile of the stored location for the transaction. Similarly, a transaction density for the payment system may be used, such that a smaller threshold may be used for areas from which the payment system receives a larger number of payment transactions and a larger threshold may be used for areas from which the payment system receives a smaller number of payment transactions. As another example of information regarding a transaction that may be used to set a threshold, information on one or more parties to a transaction may be used to set the threshold. For example, if a payer to a transaction that is a potential match based on the information submitted by the user has engaged in many prior transactions with the user, a larger threshold may be used than if the payer has never previously paid that user. As another example, if the user has engaged in more than a threshold number of prior transactions using the payment system and has not been detected to have fraudulently claimed a transaction or attempted to fraudulently claim a transaction, a larger threshold may be used because the user may be identified by the system as trustworthy.

In some embodiments, there may be multiple pieces of additional information stored for a transaction, and the facility may determine in block 310 whether there is a match based on one, some, or all of those pieces of additional information and the additional information received in block 308. Accordingly, while in some cases multiple pieces of additional information may be stored for a transaction, the user need not provide each of those pieces of additional information and may instead provide one or some of them, on which the determination of block 310 will be made.

In some embodiments, such multiple pieces of information may be used by the system when a user has incorrectly entered information regarding a transaction. For example, if the user has provided a correct transaction identifier and then provides an incorrect piece of additional information, if the system has stored multiple pieces of additional information for a transaction the other pieces of additional information may be used to give the user additional opportunities to provide confirmatory information to claim the transaction. For example, if the user mistakenly inputs a location, then the user may be prompted to input a time, an appearance of the payee during the transaction, or information on weather during the transaction. As another example of permitting reentry of information following an error, if the user mistakenly inputs initials, the user may be prompted to input one or both of the initials again. This may permit flexibility in cases where a payer or payee is known by a nickname or middle name but has registered with the payment system using a formal or first name. For example, if a user named Elizabeth Smith is informally known as Liz Smith, that user may be identified by the initials “E S” and “L S,” but only one of those sets of initials may be correct. In some embodiments, when a user has erroneously input initials while attempting to claim a transaction, the system may allow the user to change a first initial to account for variations in names, but may not allow changes to an initial for a last name. This constraint on the number of opportunities a user may have to provide additional information may reduce chances of fraud.

In some such embodiments, after a number of erroneous inputs, a user may be prohibited from entering further additional information regarding the transaction, or the user's account may be suspended.

In some embodiments that operate with thresholds to detect whether input information matches stored information, multiple thresholds may be used to determine whether to permit entry of different information in block 308. For example, a first, smaller threshold may be used by a server payment facility to determine whether a user's input matches stored information, and a second, larger threshold may be used to determine whether the input was close enough to justify input of different information as another chance at confirming identity. Using location as a specific example, if a user input location is within a first threshold distance of a stored location for a transaction it may be determined to be a match, and if the input location is within a second and larger threshold distance then it may be determined to be close enough to prompt a user for different information. If, however, the user input is outside of the second threshold, then the server payment facility may determine that the user may be attempting to fraudulently claim a transaction and may determine that the user is not the payee without permitting input of other information.

In some embodiments, the user may be permitted to electronically collect information to provide as additional information in blocks 308, 310. For example, a user may return to a location of a transaction and operate a client payment facility to detect a current GPS coordinate of the user's mobile device, which the client payment facility may provide to the server payment facility as additional information in block 308. As another example, a user may return to a location of a transaction and operate the client payment facility to detect information on nearby wireless networks, then provide the information to the server payment facility in block 308. As another example, some applications may collect information on movements of a user (or the user's device), such as a “bread crumb trail” of locations that the applications have detected the user/device to have visited over time. Some applications may permit retrieval of the list of locations, and times at which the locations were visited. In some embodiments, a client payment facility may retrieve information on the prior locations and times from one or more data stores associated with one or more such other applications and provided by the client payment facility to the server payment facility. The server payment facility may use the information to confirm whether the user/device was previously in a location matching a transaction and determine whether the user is a payee of the transaction.

In cases in which electronically-collected information is provided, the electronically-detected information may be compared to stored information regarding a payment transaction. This may be useful in a case where a user has incorrectly input a location manually but is able to return to the location of the transaction to carry out an electronic detection of location, or in a case where the user would prefer to use electronic detection rather than provide a manual input.

If the facility determines in block 310 that there is a match between the additional information received in block 308 and the additional information stored for a transaction, then in block 312 the facility may determine that the user is the payee of the transaction and update (or issue an instruction to another facility to update) the information stored in a data store regarding the transaction to indicate that the user is the payee. In addition, in block 312 the facility may update the information (or issue an instruction that the information be updated) regarding the transaction to change the transaction from a “pending” state to another state, such as “completed.” In block 314, the facility may also transfer funds to the payee in an amount that corresponds to the amount of the transaction. In a case that funds for the transaction were withdrawn from a payer's account and placed in escrow, in block 314 the facility may transfer the funds (including by issuing an instruction to another facility to transfer the funds) from escrow into a financial account for the payee. In a case that the funds were not escrowed, the funds may be transferred directly from the payer's account to the payee's account in block 312. In block 316, a message confirming that the transaction has been claimed may be transmitted to the payee's client payment facility for display to the payee.

If it is determined in either block 306 that the potential transaction identifier does not match any transaction identifiers stored in the data store, or if the additional information received in block 308 is determined not to match the stored additional information for a transaction that had a matching identifier, then in block 318 a message may be transmitted by the server payment facility to the client payment facility for display to the user. The message that is transmitted may indicate in any suitable manner that a corresponding transaction has not been identified.

Once the facility transmits a message in block 316 or block 318, the process 300 ends.

It should be appreciated that all embodiments are not limited to being implemented precisely in accordance with the examples of FIGS. 2 and 3, and that other embodiments are possible. For example, the process 300 of FIG. 3 was described as using a two-stage input process, by which a user first input a transaction identifier to a client payment facility and, if it matched a transaction identifier for a pending transaction, was prompted for additional information regarding the transaction. In some embodiments, a single input stage may be used in which transaction identifier and the additional information are input at the same time and transmitted to the server payment facility together. Additionally, while only a single stage of receiving additional information was illustrated in FIG. 3, in embodiments in which multiple pieces of additional information are reviewed to confirm that a user is a party to a transaction, there may be multiple iterations of receiving pieces of additional information and determining whether those pieces of additional information match stored information for a transaction.

In the example above, a payment system processes payment transactions that enable parties to be anonymous to one another or exchange limited personal identification information. It should be appreciated, however, that a payment system may additionally or alternatively implement conventional techniques for initiating and processing payment transactions, including through the input by one or more of the parties of personal identification information regarding parties to the transaction.

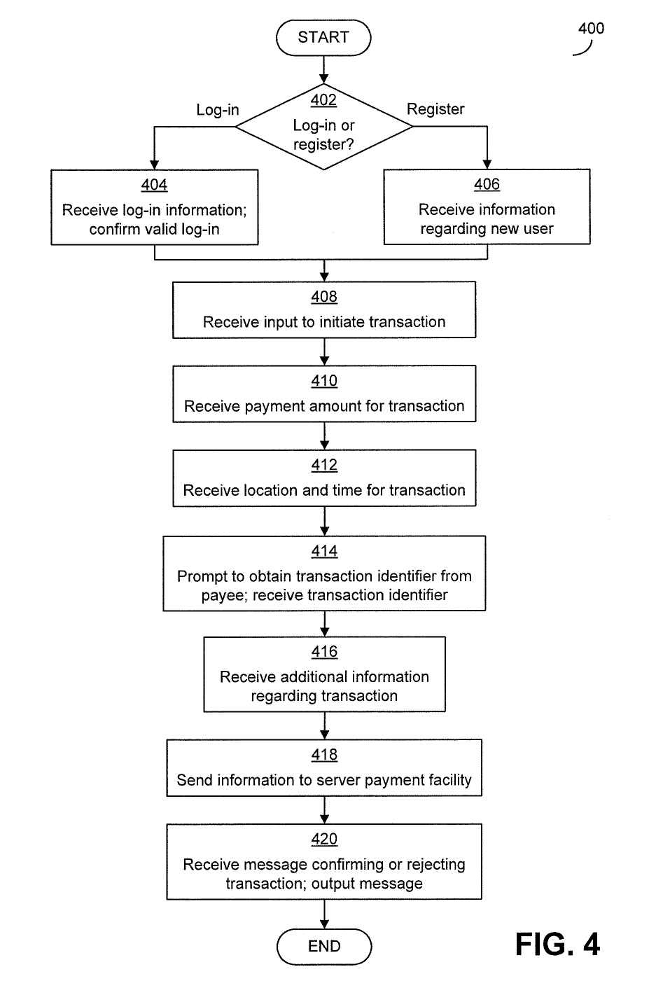

The illustrative processes of FIGS. 2 and 3 were described in connection with the server payment facility that may be executed on one or more servers of a payment system. As should be appreciated from the foregoing, however, a client payment facility may be executed on one or more devices operated by users to interact with the server payment facility and to receive from users information regarding a payment transaction. FIGS. 4-6 illustrate processes that may be implemented by a client payment facility in some embodiments.

FIG. 4 illustrates an example of a process that may be implemented by a client payment facility for initiating a payment transaction with a payment system. As in the prior examples, for ease of description the process 400 of FIG. 4 will be described in connection with a payer initiating a payment transaction. It should be appreciated, however, that in some embodiments payees may initiate transactions.

Prior to the start of the process 400, a user of a computing device may download at least a portion of the client payment facility for execution on the computing device. The client payment facility may be implemented in any suitable manner, including as one or more web pages or as an application. In some embodiments, in addition to downloading the facility the user may install the facility before it is executed on the client device.

The process 400 begins in block 402, in which the client payment facility prompts a user to either log-in to an existing account or register with the payment system to create a new account. If the user selects to log-in to an existing account, then in block 404 the client payment facility prompts for and receives as input from the user suitable log-in information and transmitted to the server payment facility, as described above in connection with block 202 of FIG. 2. If the user selects to register a new account, then in block 406 the facility prompts the user to enter various forms of information, including any of the types of information about the user or financial accounts of the user described above. It should be appreciated that embodiments are not limited to operating with any particular type(s) of information regarding users or financial accounts, and thus any suitable type(s) of information may be received in block 406. In blocks 404 and 406, once the user inputs the information the facility prompted for, the facility transmits the information to the server payment facility.

Once the client payment facility has logged-in or registered the user, the facility may provide the user the option to initiate a payment transaction, to claim or authorize an existing transaction, to view information regarding past transactions or pending transactions, or perform any other suitable task relating to payment transactions. In the example of FIG. 4, in block 408 the client payment facility receives an input from the user indicating that the user would like to initiate a payment transaction acting as the payer. In block 410, the facility prompts for and receives the payment amount for the transaction.

In block 412, the facility receives a location and time for the transaction. In some cases, the location and time of the transaction may be electronically detected by a computing device executing the client payment facility. For example, the client payment facility may automatically access a clock and an integrated GPS receiver of the device of the computing device on which the facility is executing. As an alternative, the information may be received in block 412 as input from the user or in any other suitable manner.

In block 414, the facility prompts the user to obtain a transaction identifier from the payee. As should be appreciated from the foregoing, discussion of FIGS. 2 and 3, any of various types of information may be used as a transaction identifier and, accordingly, the facility may prompt for any of various types of information and receive such types of information. In some embodiments, the payment system may enable parties to a transaction to use any one of multiple different types of transaction identifiers and, thus, in block 414 the user may select the type of transaction identifier to be provided. For example, the client payment facility may enable the parties to use a string of characters as a transaction identifier. If this is the only option or is selected by the user from available options, the facility may prompt the payee to input the string of characters or may prompt the payer to obtain the string from the payee. As another example, the client payment facility may enable the parties to use a symbol as a transaction identifier. If this is the only option or is selected by the user from available options, the facility may prompt the payee to select a symbol from a displayed set of available symbols. As a further example, the client payment facility may enable the parties to use biometric information for the payee as a transaction identifier. If this is the only option or is selected by the user from available options, the facility may prompt the payer to obtain the biometric identifier from the payee. Obtaining the biometric identifier from the payee may include capturing a photograph of the face of the payee using a camera, capturing a fingerprint of the payee using a fingerprint scanner or a camera, obtaining an audio clip of the payee speaking using a microphone, or obtaining any of various other types of biometric identifiers. In embodiments where such cameras, fingerprint scanners, or microphones are used, they may be integrated components of a computing device executing the client payment facility and the facility may operate these components of the device.

In block 416, the client payment facility may also prompt for additional information regarding the payment transaction. The facility may prompt for any one or more of various types of additional information, including the exemplary types discussed above in connection with FIGS. 2 and 3, and the facility may receive any one or more of those types of additional information. As discussed above in connection with block 412, in some cases information such as location and time may be electronically determined by the client payment facility. In some cases, in block 416, some additional information may be collected by the client payment facility from electronic sensors of the computing device on which the facility is executing, or by retrieving information from one or more other devices via a network. The facility may collect any suitable information relating to the environment in which the payment transaction was initiated, or a context of the payment transaction, as embodiments are not limited in this respect. For example, information relating a weather of the location at which the transaction is being initiated may be collected, such as via temperature, humidity, light, and/or barometric pressure sensors of the device or by retrieving weather information from a server via the Internet. As another example, information relating to the ambient sounds or imagery of an environment may be collected through using a camera and/or microphone of the device. As still another example, information on one or more wireless networks within range of the device may be collected, such as a list of MAC addresses for nearby wireless access points or a list of SSIDs used by wireless networks supported by those access points.

Once the information regarding the payment transaction is collected in blocks 408-416, in block 418 the client payment facility transmits the information to the server payment facility. In response, in block 420 the client payment facility receives a message from the server payment facility that indicates that the transaction has either been confirmed and the information has been stored, or that the transaction has been denied. The transaction may be denied for any suitable reason, including that the payer has insufficient funds to cover the amount of the transaction.

Once the message is received in block 420, the process 400 ends.

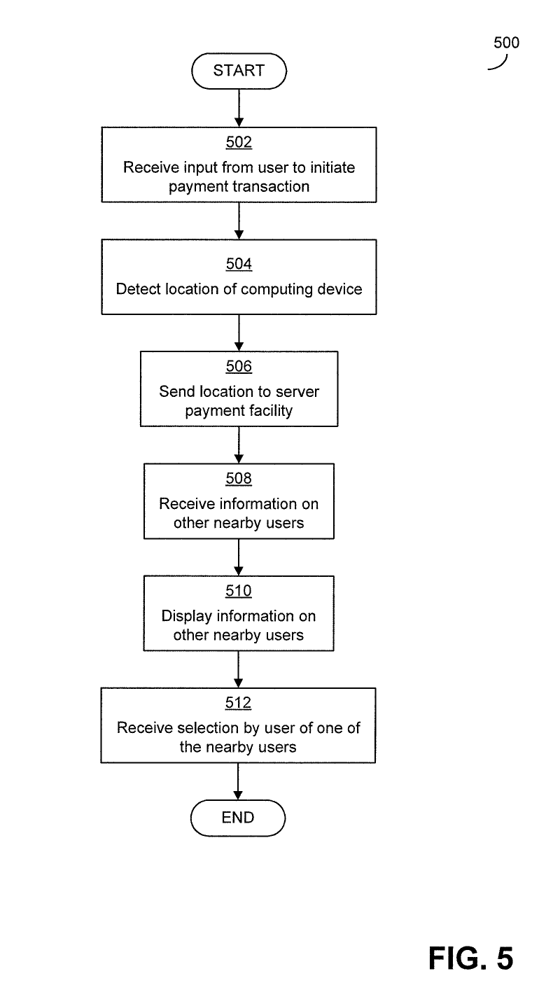

FIG. 5 illustrates a process 500 that may also be carried out by a client payment facility in some embodiments for initiating a payment transaction. In the exemplary process 400 of FIG. 4, no information regarding the payee of the transaction was input, other than in the case that the transaction identifier was biometric information for the payee. In some embodiments, however, a client payment facility may display to a user a list of other users of the payment system who are nearby and the user may select one of those other users to be a payee.

Prior to the start of the process 500 of FIG. 5, multiple users may register with the payment system. As part of registering, each user may provide to the system information regarding the users, such as at least a part of a name and/or a facial image. In addition, in some embodiments the users may select a level of privacy to use in sharing their information regarding other nearby users. For example, each user may select whether to display a part of their name or a facial image to other nearby users, or whether to display no information to nearby users. In addition, each user may install on a computing device, such as a mobile device that they carry with them, a client payment facility that periodically collects their current location and reports it to the server payment facility.

The process 500 begins in block 502, in which the client payment facility receives an input from the user requesting to initiate a transaction. (As in the prior examples, for ease of description the process 500 will be described in connection with a payer initiating a payment transaction. It should be appreciated, however, that in some embodiments payees may initiate transactions.) In response, in block 504 the client payment facility determines a current location of the device on which the facility is executing. The facility may determine the location in any suitable manner, including by obtaining the location from a GPS receiver integrated in the computing device or prompting the user for the location. After determining the location, the facility transmits the location to the server payment facility in block 506.

In block 508, in response to the transmission of the location, the client payment facility receives from the server payment facility information on a set of other users of the payment system who are within a threshold distance of the current location of the user/device. The information on the set of other users may include a set of names (or parts of names) and/or facial images of those other users. The names and facial images may be those provided by those users to the payment system at the time the users registered with the payment system, and in some embodiments the server payment facility may transmit a name and/or a facial image in accordance with a privacy setting set by each user. In accordance with such privacy settings, for some users that may be nearby, the server payment facility may transmit no information and thus not inform the requesting user that these users are nearby. Once the information on the nearby users is received, the information (e.g., names and/or facial images) is displayed by the client payment facility in block 510.

In accordance with embodiments described herein, the information received in block 508 may not include any personal identification information for the nearby other users. The information may not include information that can be used to directly identify or contact these other users, such as a name, phone number, e-mail address, etc. for the other users.

After displaying the facial images to the user in block 510, in block 512 the client payment facility receives an input from the user selecting one of the facial images, which indicates that the user would like to initiate a payment transaction with the user corresponding to the selected facial image. After the user selects the image, the process 500 ends. Following the process 500, the client payment facility may carry out a process similar to that of the process 400 to receive other information regarding a transaction from a user, including a payment amount or additional information regarding the transaction. However, in some embodiments, as the user has selected the facial image of the intended payee, that facial image may be used as the transaction identifier and further input of a transaction identifier is not necessary. After receipt, the client payment facility may transmit this other information together with the selected facial image to the server payment facility to initiate the payment transaction. In such a case that the facial image was selected, the identity of the user corresponding to the selected facial image may therefore be known by the payment system at the time the transaction is initiated, and may be uploaded by a client payment facility and/or stored by a server payment facility along with other information regarding the payment transaction. In some such embodiments, however, the transaction may be marked as pending until that user claims the transaction as the payee of the transaction, as in FIG. 3. However, in some such embodiments the user whose facial image was selected may not be required to provide as much information to confirm his or her identity as the payee as in other transactions, as the payment system may already store information identifying that user as the payee. For example, in some such embodiments the user may only be required to submit the transaction identifier and may not be required to submit additional information, or thresholds associated with evaluating additional information may be changed to allow for greater imprecision.

The exemplary process 500 of FIG. 5 was described as operating with a current location of the user/device. In some embodiments, a user may be able to retroactively initiate a transaction to a payee using a process similar to that of FIG. 5 by specifying a time in the past that the user was near the intended payee. For example, if at the end of the day the user realizes that he forgot to tip a person with whom he interacted earlier and would like to tip that person, the user may specify to the client payment facility that he was near the person at a particular time (e.g., 2 pm that afternoon). As mentioned above, the client payment facility of each user may track the locations of those users over time and, thus, the server payment facility may have access to a “breadcrumb trail” of locations visited by the users over time. Using that information, the server payment facility may determine the location of the user at the specified time (2 pm) and, using that information, identify other users who were nearby at that time and send facial images for those users to the user's client payment facility. If the intended payee's face is in the set of facial images, then the user may select that image and proceed with initiating a payment as in the process 500.

As should be appreciated from the foregoing, in some cases a facial image of a payee—preexisting from registration of the payee or captured on-the-fly by a client payment facility of a payer—may be used as a transaction identifier for a payment transaction and, in some such embodiments, the payment system may also have access to facial images for each user. Accordingly, in some embodiments, in response to receiving information regarding a payment transaction for which the transaction identifier is a facial image, the server payment facility may access its set of stored facial images for users to determine whether a registered user is the payee of the transaction. To do so, the server payment facility may use (either itself, or through requesting that another facility do so) known facial image processing techniques to compare the facial image that is a transaction identifier to each of the facial images for the set of registered users. If the server payment facility identifies a match between the transaction identifier and a facial image for a registered user, then in some embodiments the server payment facility may identify that registered user as the payee and complete the transaction by transferring funds. In other embodiments, the server payment facility may not simply identify the registered user as the payee, but may instead notify the registered user that they may have a transaction waiting to be claimed. Such a notification may be made by e-mail or any other suitable communication. If the registered user attempts to claim the transaction, the server payment facility may test whether the registered user was correctly identified as the payee through requesting additional information about the transaction and determining whether that additional information matches stored additional information for the transaction, as discussed above in connection with FIG. 3.

While a case in which the server payment facility may use existing facial images to attempt to automatically determine a payee or probable payee of a payment transaction, it should be appreciated that any of various other types of information may be used in this manner. For example, as discussed above the server payment facility may have access to a set of locations visited by each of the registered users over time. Using that information, the server payment facility may be able to identify likely payees of transactions. For example, if only one registered user was located within a threshold distance of a location of a transaction at the time the transaction was initiated, it may be likely that the registered user is the payee of that transaction. However, in such a case it may be advantageous to use additional information regarding the transaction to confirm that the registered user is the payee, as there is a chance that the payer of that transaction intended to pay a person who is not yet a registered user and, therefore, a person that the server payment facility would not have access to location data for.

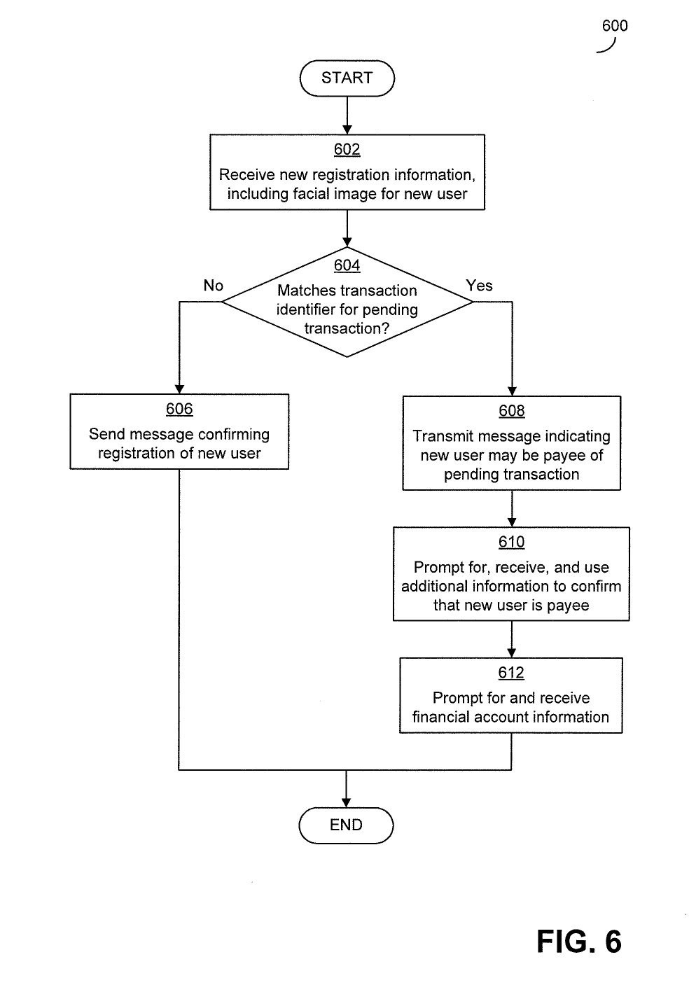

It should be appreciated that users of payment systems operating in accordance with techniques described herein are not limited to initiating payment transactions only with users who are also already registered users of the payment system. For example, in some embodiments a user may initiate a payment transaction that the payee may claim prior to or as a part of registering with the payment system. FIG. 6 illustrates an example of a process that may be implemented by a server payment facility in some embodiments that permit such payment transactions.

Prior to the start of the process 600 of FIG. 6, a payer may have initiated a payment transaction by providing to a payment system information regarding the payment transaction. The information provided by the payer to the payment system may include information that corresponds to information that the payment system stores on registered users of the payment system. For example, the information on the payment transaction may include a facial image of the payee that is used as a transaction identifier for the transaction, and the payment system may store facial images for each registered user and may request facial images from each user during registration. Though, it should be appreciated that embodiments are not limited to operating with facial images. A similar process may be carried out with fingerprints, voice prints, device identifiers for devices operating by users, or other suitable information regarding a user that may be collected by the payment system.

The process 600 begins in block 602, in which a server payment facility receives a new registration request from a user. The registration request may include any of the types of information regarding users that have been discussed above, including personal identification information for the user and information identifying a financial account of the user. In the example of FIG. 6, the information that is received in block 602 includes a facial image of the new user. Upon receipt of the information, the server payment facility may store the information in one or more data stores.

In block 604, the server payment facility determines whether the facial image that is received is a match for one or more pending transactions that have been initiated with the payment system. The determination of block 604 may be made in any suitable manner, including any of the exemplary techniques discussed above in connection with block 306 of FIG. 3. In short, the server payment facility may use known facial image processing techniques (either itself, or by requesting that another facility use such techniques) to determine whether the facial image of the new user is a likely match to a facial image used as a transaction identifier for one or more previously-initiated transactions.

If in block 604 the server payment facility determines that the facial image of the new user does not match any facial images for pending transactions, then in block 606 the server payment facility transmits a message confirming registration and the process 600 ends.

If, however, in block 604 the facility determines that the facial image matches facial images for one or more pending transactions, then in block 608 the server payment facility transmits a message indicating that the user may be the payee of one or more transactions. Subsequently, in block 610, the server payment facility may prompt for, receive, and use additional information to determine whether the new user was correctly identified as the payee for one or more of the pending transactions. The facility may make the determination of block 610 in any suitable manner, including using techniques described above in connection with blocks 308, 310 of FIG. 3. Once the facility has determined whether the new user is a payee of any pending transactions, then in block 612 the server payment facility may prompt the new user (e.g., by transmitting a message to a client payment facility of a device operated by the new user) to input information on a financial account of the new user (if such information was not received in block 602), and receive that information from the new user. Once the information on the financial account is received, the process 600 ends.

In embodiments in which payers are able to pay people who are not registered users, there is a risk that a payment transaction may never be claimed by a payee. Accordingly, in some embodiments (including some in which payers can only pay registered users), the server payment facility may maintain expiration times/dates for payment transactions. In such embodiments, after a threshold period of time has passed, the server payment facility may cancel the transaction. If any funds have already been transferred as a part of the transaction (e.g., transferred to escrow), the funds may be refunded to the payer when the transaction is canceled.

The process 600 was described as operating in connection with a party who does not initiate a payment transaction (in the example, a payee) and who is not a registered user of the payment system at a time that the payment transaction is initiated. In some embodiments, in addition to or as an alternative to not requiring that payees (or other non-initiating parties) be registered users of the payment system at the time the payment transaction is initiated, in some embodiments the payment system may not require that initiating parties (e.g., payers) be registered users of the payment system at the time that the payment transaction is initiated.

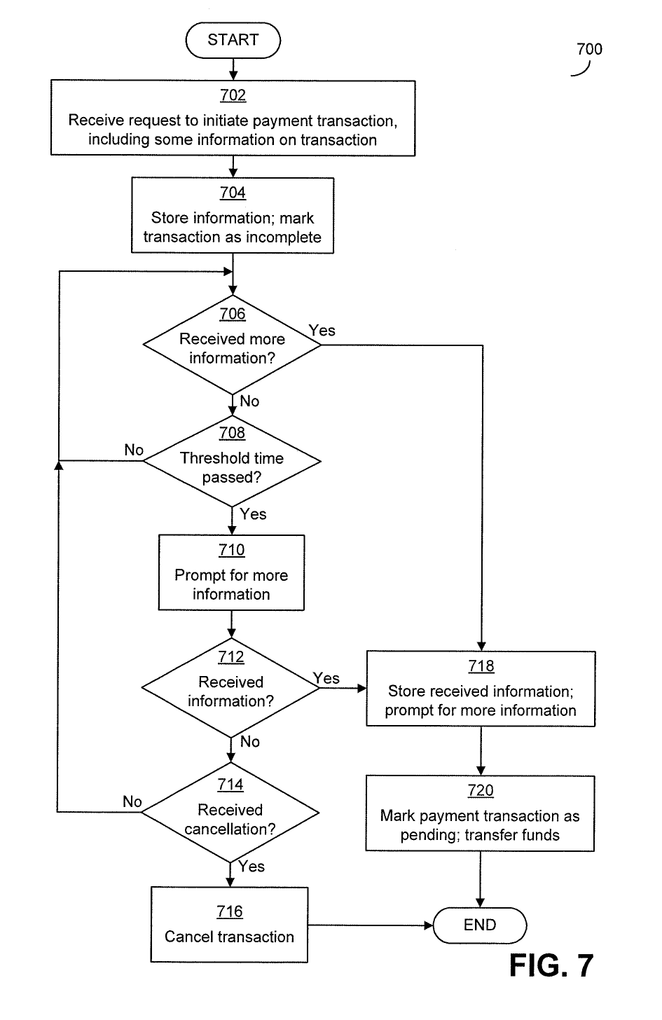

FIG. 7 illustrates an example of a process 700 that may be implemented by a server payment facility in some embodiments to process a payment transaction from an unregistered user. Prior to the start of the process 700, a new user may have downloaded a client payment facility (e.g., as one or more web pages or as an application) onto a computing device operated by the user and executed the facility. The user may use the client payment facility to interact with the server payment facility, and vice versa, as the payment system (lacking information about the unregistered user) may not be able to interact with the unregistered user in any other manner.

The process 700 begins in block 702, in which the server payment facility receives information identifying a payment transaction that a user is initiating with the payment system. The information that is received in block 702 may include any of the various types of information discussed above in connection with FIG. 2, including a transaction identifier or additional information. In some embodiments, only some of the information in connection with FIG. 2 may be received in block 702, such that some information may be omitted (e.g., additional information, or payment amount, or transaction identifier, etc.).

At the time the information is received in block 702, the payment system may not store any information regarding the user that is initiating the payment transaction. For example, the payment system may not store any personal identification information for the user, and the system may not store any information on any financial accounts of the user. Accordingly, at a time that the transaction information is received, the payment system may be unable to process the transaction, as the payment system at the very least may not be able to identify any financial account that may be the source of funds for the transaction. Regardless, in block 704 the payment system may store the received information as well as a time at which the information was received.

The payment system may then determine, in block 706, whether more information has been received about the new user or about the payment transaction, and may determine in block 708 whether a threshold amount of time has passed. If not, then the server payment facility may continue in a loop determining whether the information has been received or the time has passed. When the facility determines that the threshold time has passed (any suitable threshold may be used, including 12 hours, 24 hours, 48 hours, etc.), then the server payment facility in block 710 transmits a message to the client payment facility prompting the user to input additional information. Transmitting such a message may cause a notification to be audibly and/or visually presented by a computing device operated by the user and on which the client payment facility is executing.

After transmitting the message in block 710, the facility may determine in block 712 whether the facility has received the prompted information. If not, then the facility determines in block 714 whether it has received a cancellation message from the user, indicating that the user has decided not to proceed with the transaction and canceling the transaction. If the facility determines that the user has provided a cancellation message, then in block 716 the facility may delete the information received in block 702, after which the process 700 ends. If, however, the facility determines in block 716 that the user has not provided a cancellation message, then the process 700 returns to block 706.

If, in block 710, the facility determines that the user has provided the prompted information, or if the facility determines in block 706 that the user has provided more information, then in block 718 the server payment facility may store the information that is received and, if necessary, prompt the user for more information. Once a complete set of information regarding a payment transaction and/or an initiator of the payment transaction is received and stored, then in block 720 the server payment facility may mark the payment transaction as pending and/or transfer funds into escrow, after which the process 700 ends.

As should be appreciated from the foregoing, in some embodiments anonymity between payer and payee is an important feature of the payment system that may extend the utility of the payment system into transactions that conventional payment systems cannot process. However, while in some cases absolute anonymity between the parties to a transaction may be important to those parties, in other cases it may not be important. For example, a user may use the payment system to pay both strangers and good friends, and the degree of anonymity that would be useful to the user may vary depending on the payee. Further, in some cases it may be important that a payee know who is transferring funds, such as in the case that a debt is being paid by a payer. Accordingly, in some embodiments a party that initiates a transaction (again, for ease of description below, the payer) may set a privacy setting for that transaction that controls how much information relating to that party is provided by the payment system to another party to the transaction.

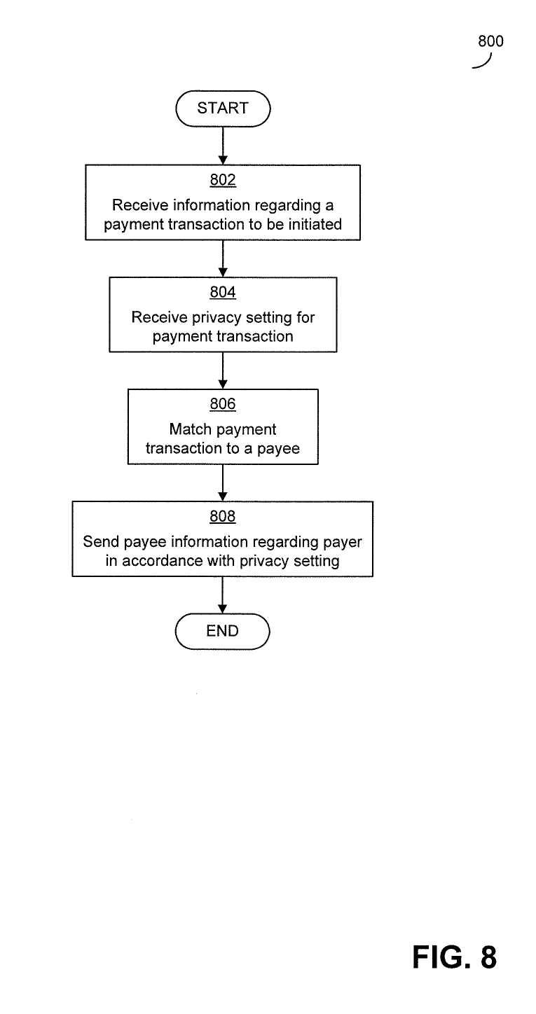

FIG. 8 illustrates an example of a process that may be implemented by a server payment facility in some embodiments to share information regarding payers and payees of transactions in accordance with a privacy setting for each transaction. It should be appreciated that embodiments are not limited to implementing privacy levels in any suitable manner. Prior to the start of the process 800, a first user registers with a payment system and provides various pieces of information regarding himself or herself to the system, which may include personal identification information. Information such as a legal name, phone number, street address, e-mail address, and facial image may be provided to the system. Any of these various pieces of information may therefore be stored by the system and may be available to be shared with a payee of a transaction, per a privacy setting for a transaction.

The process 800 begins in block 802, in which the server payment facility receives from a client payment facility multiple pieces of information regarding a payment transaction that the first user is requesting be initiated. Any suitable information may be received in block 802, including any of the examples of types of information described above in connection with FIG. 2.

In block 804, the server payment facility receives input regarding a privacy setting for the transaction. The privacy setting may be received in any suitable format, as embodiments are not limited in this respect. In some embodiments, the privacy setting may be received as a listing of pieces of information regarding the payer that the payer selected to be shared with the payee, which in some cases may be no information. Such information may include a name, facial image, contact information, or other information regarding the payer. In other embodiments, the privacy setting may be received as an indication of a privacy “level” that, as discussed above, corresponds to a particular set of information to be shared. In embodiments in which such privacy levels are used, one level may correspond to the sharing of no information. Once the information is received in blocks 802, 804, the information is stored.

Subsequently, in block 806, the server payment facility receives input from a second user that is claiming the transaction and, in accordance with techniques described above, the facility confirms that the second user is the payee of the transaction for which the information was received in blocks 802, 804. In accordance with the privacy setting, the server payment facility determines in block 808 what information regarding the payer is to be sent to the payee. If any information about the payer (e.g., name, phone number, e-mail address, facial image) is to be sent to the payee, then in block 808 that information is sent to a client payment facility operated by the payee such that it may be displayed to the payee by the client payment facility. After the information is transmitted, the process 800 ends.

In the embodiment of FIG. 8, the privacy setting for a transaction was manually set by a party initiating the transaction (e.g., the payer). It should be appreciated that embodiments are not so limited. In some embodiments, rather than the payer manually specifying the information to be shared, the server payment facility may automatically set the privacy setting. In other embodiments, a suggested privacy setting for a transaction may be set automatically, but may be approved or changed by a payer.

In embodiments that implement an automatic privacy setting, the server payment facility may set the privacy setting based on any suitable factors. In some embodiments, the privacy setting may be set based on an identity of the parties, or an estimated identity of the parties, to a transaction. For example, if the server payment facility is able to identify likely parties to a transaction, then the privacy setting may be set based on a history of interactions between those parties, which may be indicative of how important anonymity is to these two parties or how much anonymity may be important. As another example, in embodiments in which a party initiating a transaction (e.g., the payer) is given the option of identifying the other party using personal identification information such as a name or contact information, the server payment facility may set the privacy setting according to whether personal identification information is received. For example, in transactions in which the server payment facility receives from an initiating party (e.g., the payer) personal identification information regarding another party (e.g., the payee), the facility may set the privacy setting so as to share more information between the parties. The facility may be configured to do so because, if the payer inputs the personal identification information for the payee, then it may be the case that the payer knows the payee and is not as concerned about keeping personal identification information from the payee. In some such embodiments, in cases in which the facility does not receive personal identification information for another party, the facility may set the privacy setting so as to share less personal identification information between the parties.

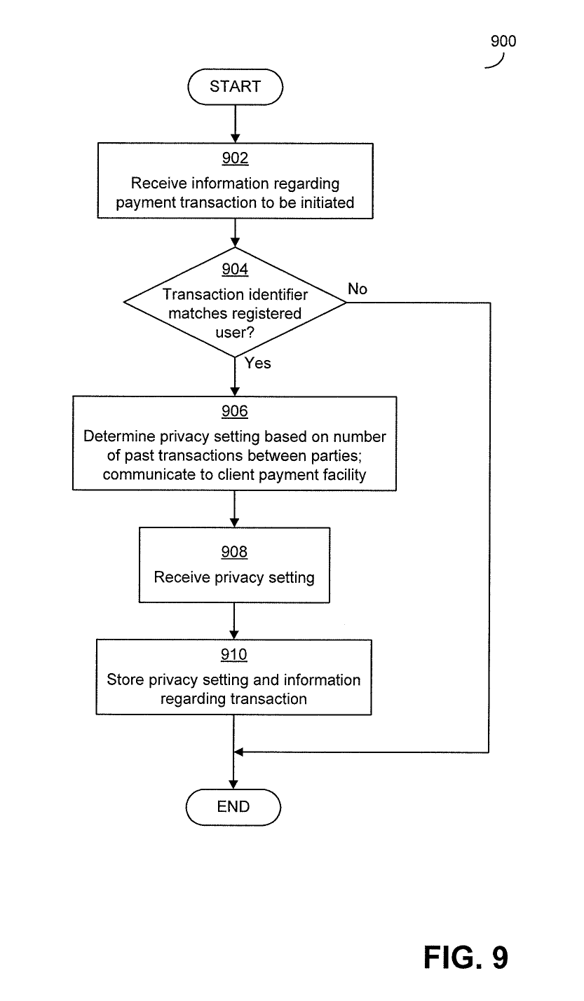

FIG. 9 illustrates an example of a process that may be implemented in some embodiments by a server payment facility to automatically set a privacy setting for a transaction. Prior to the start of the process 900, users may register with a payment system and exchange funds using payment transactions with the payment system. As part of registering, each user may provide to the payment system a facial image.

The process 900 begins in block 902, in which the server payment facility receives information regarding a payment transaction from a payer of the transaction. The information that is received may include any suitable information regarding a transaction, including examples given above. Information may also include information that could be used by the payment system to identify a party, based on a comparison by a server payment facility of the received information to information on registered users of the payment system. In the example of FIG. 9, the information may include a facial image for a payee of the transaction.

In block 904, the server payment facility determines whether the facial image of the payee matches a facial image for a registered user. If not, then the process 900 ends. If, however, the facial image is determined to match one registered user, then in block 906 the facility determines from information regarding past transactions a number of transactions in which the payer has engaged with the registered user that was identified as a likely payee in block 904. Based on the number of transactions, the server payment facility may then select a privacy setting for the transaction. For example, as a number of previous transactions between the payer and payee increases, an anonymity between those parties may be lowered such that more personal information is disclosed. The server payment system may have various thresholds of numbers of prior transactions where each threshold is associated with different privacy settings, such that as each threshold is crossed by an increasing number of transactions, more information is shared. In embodiments that implement a privacy setting as a series of levels, each threshold may be associated with a level.

Once the privacy setting is automatically determined in block 906, the privacy setting may be communicated by the server payment facility to the client payment facility operated by the payer. The setting may be communicated such that it may be approved by the payer, which may be carried out in any suitable manner. In block 908, the server payment facility may receive from the client payment facility a privacy setting for the transaction, which may be the same or different from the one transmitted in block 906. The privacy setting may be different in a case that the payer does not approve the automatically-determined privacy setting and operates a client payment facility to set another privacy setting. Once the privacy setting is received in block 908, the server payment facility stores it in block 910 along with the information received in block 902, and the process 900 ends.

While the example of FIG. 9 was discussed in connection with identifying likely payees based on facial images, it should be appreciated that other information may be used to identifying likely payees. For example, in some embodiments location information or other information may be used to determine likely payees, as should be appreciated from the foregoing discussion in connection with FIGS. 5-6. Any other suitable form of information may alternatively be used to identify a likely payee and, using that information, set a privacy setting for a transaction.

Further, while the embodiment of FIG. 9 was described as automatically setting a privacy setting based on a number of transactions between a payer and a payee, embodiments are not so limited and the privacy setting may be based on other information regarding prior transactions between a payer and payee. For example, in some embodiments a privacy setting for a last transaction between the payer and payee may be retrieved and automatically set in block 906 as the privacy setting for the new transaction.

Examples above did not explicitly discuss what kind of confirmation message a payer might receive at a client payment facility, from the payment system, when the payer requests to initiate a payment transaction to pay a payee using the payment system. Particularly in a case where goods or services are exchanged and the parties are to remain anonymous to one another, it may be important for the payee to know that the payer has truly initiated a payment transaction with the payee. For example, if a payer wishes to use the payment system to pay a retail store for items purchased at the retail store, a clerk at the store may wish to receive confirmation that an anonymous payer has initiated the transaction and that the payment system is able to complete the transaction will complete before the clerk allows the anonymous payer to leave the retail store with the items.

In various examples described above, the payment system has predicted an identity of a payee based on information about a payment transaction, such as information associated with a payee like a facial image of the payee. In some embodiments, a server payment facility may similarly predict an identity of a payee and use that information to determine a payment confirmation message uniquely or distinctively associated with the payee in the payment system. The server payment facility may then transmit the confirmation message to a payer's client payment facility and the client payment facility may output (e.g., display) the message. The payer may then show the confirmation message to the payee and, because the confirmation message is uniquely or distinctively associated with the payee in the payment system, the payee may be more comfortable that the payer properly initiated the payment transaction and that the transaction will be completed by the payment system.

FIG. 10 illustrates an example of a process that may use such a confirmation message. Prior to the start of the process 1000 of FIG. 10, a user may register with the payment system. As part of registering, the user may provide any suitable information regarding himself or herself, including any of the examples of information described above. In some cases, the user may be an agent of another person, such as an agent of another human or of a business, such as an employee of a business. In such a case, the information regarding the user may be information regarding the business, or the user may provide to the payment system information indicating that the user is an agent of another user, where the other user may be the other person (e.g., the business). Accordingly, in some cases the information regarding the user may include financial account information for another person (e.g., for a business) but may also include information specific to the user, such as a facial image of the user. By storing a facial image for the user, or other information about the user, the payment system may enable payment transactions to be initiated with an agent of a payee, such as by one user capturing a facial image of an employee of a business to initiate a payment transaction to the business.

In addition, prior to the start of the process 1000, each user may specify one or more confirmation messages to the payment system which are to be used to confirm that the user has initiated a payment transaction properly. As will be appreciated from the discussion below, a payment system that enables users to specify confirmation messages may enable a user to specify multiple payment messages to mitigate fraud. For example, a user may specify different payment messages that are to be used when different conditions are met. Thus, the user can anticipate which of various payment messages will be displayed based on conditions surrounding the transaction, and identify fraud if the expected payment message is not displayed.

The process 1000 begins in block 1002, in which a server payment facility receives information from one party to a transaction (e.g., the payer) requesting that a payment transaction be initiated. The information may be received in any suitable manner, and may include any suitable information, including examples described above in connection with FIG. 2. Upon receipt of the information, the information may be stored by the facility and, in some cases, may be processed such as by transferring to escrow funds in an amount corresponding to the amount of the transaction. While not illustrated in FIG. 10, in some embodiments that perform such processing, if the server payment facility encounters an error in such processing (e.g., there are insufficient funds to cover the transaction), then the facility may transmit an error message and the process 1000 may end. The server payment facility may also determine whether all necessary information has been received, both for the payment transaction and the party requesting that the transaction be initiated (e.g., the payer). If any information has not been received, the transaction may be flagged as incomplete and held as pending, such as discussed above in connection with FIG. 7. Accordingly, in some embodiments, before proceeding beyond block 1002, the server payment facility may determine that the party initiating the transaction (e.g., the payer) has satisfied all of that party's obligations to the payment system for providing information, providing funds, or otherwise providing anything required by the payment system to fully initiate a payment transaction. Following block 1002, therefore, in some embodiments a payee (or other party to a transaction) may simply claim or authorize a transaction for that transaction to be completed by the payment system and funds transferred, as all other information regarding the initiating party, the source of funds for the transaction, or the transaction itself may be stored by the payment system.

The information that is received in block 1002 may include information on the other party to the transaction (e.g., the payee) that would enable the server payment facility to identify the other party using information on users that is available to the server payment facility. Any suitable type of information may enable a server payment facility to identify another party, examples of which are described above in connection with FIGS. 6 and 9. For example, the information received in block 1002 may include a facial image of a payee.

Based on the information regarding the payee (e.g., a facial image), in block 1004 the server payment facility attempts to identify the payee of the transaction, using information regarding registered users of the payment system that is stored in one or more data stores accessible by the server payment facility.

If the server payment facility determines in block 1006 that it was not able to identify the payee, then in block 1008 the facility transmits a message to the client payment facility operated by the payer (and from which the information was received in block 1002) indicating that the payee was not identified, but that the payment transaction was received. Such a message may be transmitted by the server payment facility to provide some confirmation to the payee of the transaction that the transaction was received and processed. Though, the message may not be a message specifically tailored to the payee and thus may not provide as much assurance to the payee as a customized message.

The message transmitted in block 1008 may include any suitable information, including information indicating that the transaction was processed, such as by confirming that funds in an amount corresponding to the amount of the payment transaction have been transferred to escrow. The message may include any suitable information regarding a payment transaction or parties to a transaction, as embodiments are not limited in this respect. For example, the message may, in some cases, identify the amount that was transferred, a date or time of the transaction, and/or information regarding a basis of the transaction, such as a description of goods or services exchanged in the transaction. The message may indicate that the payer has satisfied his/her obligations under the transaction and that the transaction may be ready to be claimed. The message may be formatted in any suitable manner, including according to examples described below in connection with FIG. 11. The message that is transmitted in block 1008 may be a default message, having a default formatting for the payment system.

If, however, in block 1006 the server payment facility determines that it was able to identify the payee in block 1004, then the server payment facility may determine in block 1010 whether that payee has configured one or more confirmation messages with the payment system. If the facility determines in block 1010 that the payee has not configured confirmation messages, then the facility may transmit a message as in block 1008, discussed above.

If, however, the facility determines in block 1010 that the payee has configured one or more confirmation messages, then in block 1012 the server payment facility may either select the one confirmation message (in a case there is only one message) or (in a case there are multiple messages), select one of the confirmation messages based on the condition(s) associated with those messages. The confirmation messages selected in block 1012 may include any suitable content, such as any of the examples of content of messages discussed above in connection with block 1008. The messages may also be formatted in any suitable manner, including according to examples of formatting described below in connection with FIG. 11.

Each confirmation message may also be associated with any suitable condition or set of conditions, as embodiments are not limited in this respect. In some embodiments, the condition(s) associated with a message may include one or more associated with a time, such as a time of day, day of week, time of year, or any other suitable time. As another example, the condition(s) may be associated with an amount of the payment transaction, such as having a maximum or minimum amount, or range, of funds associated with the confirmation message. As a further example, the condition(s) may be associated with a payer, such as a gender of the payer or other information regarding the payer. As another example, the condition(s) may be associated with a basis of the transaction, such as a purpose of the transaction, goods or services exchanged in the transaction, or other information. As still another example, the condition(s) may be associated with a type of transaction identifier for a transaction, such that a different confirmation message may be used when a facial image is used as a transaction identifier than when a symbol is used as a transaction identifier. In short, any of the examples of information described herein that relate to the payment transaction or to a party to a transaction may be form the basis of a condition associated with a confirmation message, as embodiments are not limited in this respect.

Accordingly, in block 1012, in cases in which a payee of the transaction has configured multiple confirmation messages, the server payment facility may select one of the messages by comparing information regarding the transaction and/or the parties to the transaction to the condition(s) associated with the messages. If, based on the comparing, the facility identifies only one confirmation message for which each of the one or more conditions associated with the message are met, the facility may select that message. If, however, the conditions associated with multiple messages are met, then the facility may select one of the messages in any suitable manner. For example, the facility may select the first message for which it determines the conditions are met, or may select a message according to an order of messages specified by the payment system or by the payee. The facility may also randomly select a message from the set of messages for which the conditions are met.

Once the server payment facility selects the confirmation message in block 1012, then in block 1014 the server payment facility transmits the message to the client payment facility from which the information was received in block 1002. The message may then be output (e.g., displayed) by the client payment facility so a payer can show the message to a payee. Once the server payment facility transmits a message in either block 1008 or block 1014, the process 1000 ends.

The confirmation messages that are transmitted in embodiments such as the one of FIG. 10 may include any suitable content, and that content may be formatted in any suitable manner. In some embodiments that include such confirmation messages, the payment system may include a user interface that enables a user to select the content and/or formatting of a confirmation message as well as zero, one, or more conditions to associate with each confirmation message. The user interface may be implemented in any suitable manner, including as part of a client payment facility. FIG. 11 illustrates an example of a process 1100 that may be implemented by a client payment facility to receive input from a user configuring a confirmation message.

The process 1100 begins in block 1102, in which the client payment facility outputs, for display on a display of a computing device on which the facility is executing, different options for content to include in a confirmation message. In different embodiments, a confirmation message may be visual, audible, or visual and/or audible. The displayed options for content may therefore include visual and/or audible content. The options for content may include any suitable information, including any suitable information related to a payment transaction or parties to a transaction. For example, the options for content may include a payment amount for a transaction, a date/time of a transaction, a location of a transaction, a basis of a transaction such as a description of goods or services exchanged in a transaction, or other information. The options for content may also include content unrelated to the transaction or parties, but that is available for inclusion for a user to customize a message. For example, the options may include graphics, such as static or animated graphics. For example, symbols, photographs, video clips (e.g., a clip from a television program or movie, with or without corresponding audio) geometric shapes, or other images may be presented as options for inclusion. In cases where the graphics are animated, any suitable animation may be used. For example, a geometric shape may be animated to rotate or change color. As another example, a graphic of a pinwheel may be animated such that the pinwheel rotates. The options for content may include audible content as well, such as a tone or a sequence of tones, or a clip from a song. Any suitable content may be included as options that are displayed in block 1102.

In block 1104, the client payment facility may additionally output, for display on the display, options for formatting. The options for formatting may include any suitable options, which may be based on the type(s) of content that may be displayed. For example, options for a color (or colors, in the case of content that may include multiple static colors, or that may be animated to change colors) of content may be displayed, which may be options for a color of font of written text included in a message or color of a graphic included in a message. Font options such as a size or typeface of written content may be output as formatting options. Options for locations at which to display in the message content that was output in block 1002 may also be output. For audible content, volume may be output as a formatting option.

The options in block 1102, 1104 may be output in any suitable manner, as embodiments are not limited in this respect. In some embodiments, the options may be output as a list from which the content and/or format may be selected. In such embodiments, based on the selection a server payment facility may create a confirmation message. In other embodiments, the client payment facility may output the options as part of a What You See Is What You Get (WYSIWYG) editor that a user may use to create a confirmation message having the same appearance as the message will have when it is used by the payment system (e.g., as in the example of FIG. 10) to confirm payment.

In block 1106, the client payment facility may also output options for one or more conditions to associate with the confirmation message that is to be customized. The facility may output any suitable options for conditions, including any of the examples of conditions that were described above in connection with FIG. 10.

In block 1108, the client payment facility receives user selections of content, formatting, and/or options for a confirmation message and transmits the user selections to a server payment facility. Once the selections are transmitted, the process 1100 ends. Following the process 1100, in some embodiments the server payment facility may create a confirmation message in accordance with the content/formatting options and store the message in addition to the condition(s) associated with the message (if any). In other embodiments, the server payment facility may store the content/formatting options selected by the user as well as the conditions, and may generate a confirmation message dynamically based on the content/formatting options when it determines that the condition(s) is/are met and the message is to be transmitted. In cases where a user customizes the message to include information on a transaction, such as a payment amount or time/date of a transaction, a server payment facility may insert such information into a confirmation message dynamically when the facility determines that the message is to be selected and transmitted to a client payment facility.

Techniques operating according to the principles described herein may be implemented in any suitable manner. Included in the discussion above are a series of flow charts showing the steps and acts of various processes that may be implemented in a payment system that enables payment transactions between parties that are anonymous to one another or that enables a limited exchange of identifying information between parties. The inventor has recognized and appreciated, however, that the techniques described herein may be useful in contexts other than payment systems. There are other contexts in which information, goods, or services are exchanged between specific parties and in which limited exchange of personal identification information between the parties may be advantageous. For example, the inventor has recognized that there may be opportunities to use techniques described herein in the field of file sharing. In file sharing, one user may wish to transfer a file to one or more other users and may wish that a file sharing system confirm the identities of those other users while still exchanging limited personal identification information between the users. Techniques described herein may be used in such a context to permit the transmission of a file to a user based on a transaction identifier that is associated with the file. Other contexts in which information, goods, or services are exchanged may similarly benefit from the use of techniques described herein. Accordingly, embodiments are not limited to use with payments or payment systems.

The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

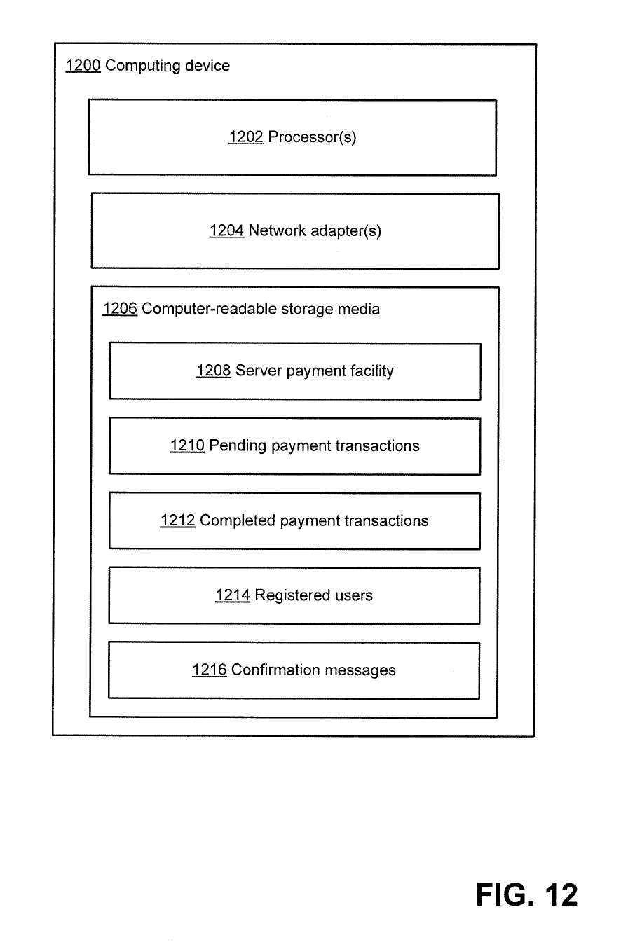

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1206 of FIG. 12 described below (i.e., as a portion of a computing device 1200) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 12 illustrates one exemplary implementation of a computing device in the form of a computing device 1200 that may be used in a system implementing techniques described herein, although others are possible. It should be appreciated that FIG. 12 is intended neither to be a depiction of necessary components for a computing device to operate as a server of a payment system in accordance with the principles described herein, nor a comprehensive depiction.

Computing device 1200 may comprise at least one processor 1202, a network adapter 1204, and computer-readable storage media 1206. Computing device 1200 may be, for example, a desktop or laptop personal computer, a server, or any other suitable computing device. Network adapter 1204 may be any suitable hardware and/or software to enable the computing device 1200 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1206 may be adapted to store data to be processed and/or instructions to be executed by processor 1202. Processor 1202 enables processing of data and execution of instructions. The data and instructions may be stored on the computer-readable storage media 1206 and may, for example, enable communication between components of the computing device 1200.

The data and instructions stored on computer-readable storage media 1206 may comprise computer-executable instructions implementing techniques which operate according to the principles described herein. In the example of FIG. 12, computer-readable storage media 1206 stores computer-executable instructions implementing various facilities and storing various information as described above. Computer-readable storage media 1206 may store a server payment facility 1208, which may implement any of the various techniques described herein. The media 1206 may additionally store a data store 1210 of information regarding pending payment transactions, as well as a data store 1212 of information regarding completed payment transactions. A data store 1214 of information regarding registered users of a payment system as well as a data store 1216 of confirmation messages associated with users may also be stored in the media 1206.

While not illustrated in FIG. 12, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method for operating a payment system that processes transactions for one more payments between at least one payers and payees, the payment system comprising at least one data storing information regarding at least one pending transaction, the at least one data store storing, for each pending transaction of the at least one pending transaction, a payment amount, identifying information for a payer, and a transaction identifier, the method comprising:
operating at least one processor to:
determine whether a potential transaction identifier input by a user matches a transaction identifier for one of the at least one pending transaction stored in at least one data store; and
in response to determining that the potential transaction identifier matches the transaction identifier for a matched pending transaction,
determine a privacy setting for the matched pending transaction, and
output for display to the user information about the matched pending transaction, the information regarding the matched pending transaction including an amount of identifying information for the payer of the matched pending transaction based on the privacy setting determined for the matched pending transaction.

2. The method of claim 1, further comprising:
prior to receiving the potential transaction identifier from the user, receiving from the payer of the matched pending transaction a request to initiate the matched pending transaction, the request comprising the payment amount for the matched pending transaction, the transaction identifier for the matched pending transaction, and the privacy setting for the matched pending transaction set by the payer,
wherein determining the privacy setting for the matched pending transaction comprises retrieving the privacy setting for the matched pending transaction from the at least one data store.

3. The method of claim 1, wherein, in a case that the privacy setting is full anonymity:
the amount of identifying information for the payer of the matched pending transaction based on the privacy setting is no identifying information for the payer; and
outputting the information regarding the transaction comprises outputting the information without including identifying information for the payer.

4. The method of claim 1, wherein, in a case that the privacy setting is not anonymous:
outputting the information regarding the transaction comprises outputting the information including all of the identifying information for the payer stored in the at least one data store.

5. The method of claim 1, further comprising:
based on the privacy setting for the matched pending transaction, selecting one or more elements of the identifying information for the payer of the matched pending transaction to output to the user; and
outputting the information regarding the transaction comprises outputting the information including the one or more elements of the identifying information for the payer.

6. The method of claim 5, wherein:
the identifying information for the payer of the matched pending transaction includes two or more of a facial image, a name, an email address, or a phone number of the payer;
selecting one or more elements of the identifying information for the payer comprises selecting from the two or more of the facial image, the name, the email address, or the phone number.

7. The method of claim 1, wherein determining the privacy setting for the matched pending transaction comprises:
in response to determining that the potential transaction identifier matches the transaction identifier for the matched pending transaction, determining a number of previous transactions between the payer and the payee; and
setting the privacy setting based on the number of previous transactions.

8. The method of claim 7, wherein:
the payment system is configured with a plurality of privacy levels in a ranking and each of the privacy levels is associated with a threshold number of transactions; and
setting the privacy setting based on the number of previous transactions comprises setting the privacy setting to a highest privacy level in the ranking for which the number of threshold transactions is exceeded by the number of previous transactions.

9. The method of claim 1, further comprising, in response to determining that the potential transaction identifier matches the transaction identifier for a matched pending transaction, issuing an instruction to complete the matched pending transaction with the user as the payee.

10. At least one computer-readable storage medium having encoded thereon executable instructions that, when executed by at least one processor, cause the at least one processor to carry out a method for operating a payment system that processes transactions for one more payments between at least one payers and payees, the payment system comprising at least one data storing information regarding at least one pending transaction, the at least one data store storing, for each pending transaction of the at least one pending transaction, a payment amount, identifying information for a payer, and a transaction identifier, the method comprising:
determining whether a potential transaction identifier input by a user matches a transaction identifier for one of the at least one pending transaction stored in at least one data store; and
in response to determining that the potential transaction identifier matches the transaction identifier for a matched pending transaction,
determining a privacy setting for the matched pending transaction, and
outputting for display to the user information about the matched pending transaction, the information regarding the matched pending transaction including an amount of identifying information for the payer of the matched pending transaction based on the privacy setting determined for the matched pending transaction.

11. The at least one computer-readable storage medium of claim 10, wherein the method further comprises:
prior to receiving the potential transaction identifier from the user, receiving from the payer of the matched pending transaction a request to initiate the matched pending transaction, the request comprising the payment amount for the matched pending transaction, the transaction identifier for the matched pending transaction, and the privacy setting for the matched pending transaction set by the payer,
wherein determining the privacy setting for the matched pending transaction comprises retrieving the privacy setting for the matched pending transaction from the at least one data store.

12. The at least one computer-readable storage medium of claim 10, wherein the method further comprises:
based on the privacy setting for the matched pending transaction, selecting one or more elements of the identifying information for the payer of the matched pending transaction to output to the user; and
outputting the information regarding the transaction comprises outputting the information including the one or more elements of the identifying information for the payer.

13. The at least one computer-readable storage medium of claim 12, wherein:
the identifying information for the payer of the matched pending transaction includes two or more of a facial image, a name, an email address, or a phone number of the payer;
selecting one or more elements of the identifying information for the payer comprises selecting from the two or more of the facial image, the name, the email address, or the phone number.

14. The at least one computer-readable storage medium of claim 10, wherein determining the privacy setting for the matched pending transaction comprises:
in response to determining that the potential transaction identifier matches the transaction identifier for the matched pending transaction, determining a number of previous transactions between the payer and the payee; and
setting the privacy setting based on the number of previous transactions.

15. The at least one computer-readable storage medium of claim 14, wherein:
the payment system is configured with a plurality of privacy levels in a ranking and each of the privacy levels is associated with a threshold number of transactions; and
setting the privacy setting based on the number of previous transactions comprises setting the privacy setting to a highest privacy level in the ranking for which the number of threshold transactions is exceeded by the number of previous transactions.

16. The at least one computer-readable storage medium of claim 10, wherein the method further comprises:
in response to determining that the potential transaction identifier matches the transaction identifier for a matched pending transaction, issuing an instruction to complete the matched pending transaction with the user as the payee.

17. An apparatus comprising:
at least one processor; and
at least one computer-readable storage medium having encoded thereon executable instructions that, when executed by the at least one processor, cause the at least one processor to carry out a method for operating a payment system that processes transactions for one more payments between at least one payers and payees, the payment system comprising at least one data storing information regarding at least one pending transaction, the at least one data store storing, for each pending transaction of the at least one pending transaction, a payment amount, identifying information for a payer, and a transaction identifier, the method comprising:
determining whether a potential transaction identifier input by a user matches a transaction identifier for one of the at least one pending transaction stored in at least one data store; and
in response to determining that the potential transaction identifier matches the transaction identifier for a matched pending transaction,
determining a privacy setting for the matched pending transaction, and
outputting for display to the user information about the matched pending transaction, the information regarding the matched pending transaction including an amount of identifying information for the payer of the matched pending transaction based on the privacy setting determined for the matched pending transaction.

18. The apparatus of claim 17, wherein the method further comprises:
prior to receiving the potential transaction identifier from the user, receiving from the payer of the matched pending transaction a request to initiate the matched pending transaction, the request comprising the payment amount for the matched pending transaction, the transaction identifier for the matched pending transaction, and the privacy setting for the matched pending transaction set by the payer,
wherein determining the privacy setting for the matched pending transaction comprises retrieving the privacy setting for the matched pending transaction from the at least one data store.

19. The apparatus of claim 17, wherein the method further comprises:
based on the privacy setting for the matched pending transaction, selecting one or more elements of the identifying information for the payer of the matched pending transaction to output to the user; and
outputting the information regarding the transaction comprises outputting the information including the one or more elements of the identifying information for the payer.

20. The apparatus of claim 19, wherein:
the identifying information for the payer of the matched pending transaction includes two or more of a facial image, a name, an email address, or a phone number of the payer;
selecting one or more elements of the identifying information for the payer comprises selecting from the two or more of the facial image, the name, the email address, or the phone number.

21. The apparatus of claim 17, wherein determining the privacy setting for the matched pending transaction comprises:
in response to determining that the potential transaction identifier matches the transaction identifier for the matched pending transaction, determining a number of previous transactions between the payer and the payee; and
setting the privacy setting based on the number of previous transactions.

22. The apparatus of claim 21, wherein:
the payment system is configured with a plurality of privacy levels in a ranking and each of the privacy levels is associated with a threshold number of transactions; and
setting the privacy setting based on the number of previous transactions comprises setting the privacy setting to a highest privacy level in the ranking for which the number of threshold transactions is exceeded by the number of previous transactions.

23. The apparatus of claim 17, wherein the method further comprises:
in response to determining that the potential transaction identifier matches the transaction identifier for a matched pending transaction, issuing an instruction to complete the matched pending transaction with the user as the payee.
